(19) United States
(12) Patent Application Publication
(10) Pub. No.: US 2021/0150925 A1
(43) Pub. Date: May 20, 2021

(54) METHODS AND DEVICES FOR EFFECTIVE LEARNING AND COMMUNICATION TECHNIQUES

(71) Applicant: Bright Effect, LLC, Chapel Hill, NC (US)

(72) Inventors: David Andrew Birchfield, Chapel Hill, NC (US); John Joseph Trionfo, JR., Newnan, GA (US)

(21) Appl. No.: 17/087,965

(22) Filed: Nov. 3, 2020

Related U.S. Application Data
(60) Provisional application No. 62/938,066, filed on Nov. 20, 2019.

(51) Int. Cl. G09B 5/14; G09B 7/02; G06Q 50/20

(52) U.S. Cl. CPC G09B 5/14; G06Q 50/20; G09B 7/02

(57) ABSTRACT

Methods, device and computer program products for providing feedback to a participant are described. A method for providing feedback to a participant includes receiving, from a transceiver, signals include audio and/or video information associated with the participant and one or more recipients, determining a first question and/or a first statement provided by the participant based on analyzing the audio information and/or the video information that was received, identifying a second question and/or a second statement provided by the one or more recipients based on the analyzing the audio information and/or the video information, generating an output comprising guidance to the participant based on one or more of the first question, the first statement, the second question, or the second statement, and transmitting the output comprising the guidance to an electronic device for display to the participant. Related devices and computer program products may perform operations of the method described herein.

### CROSS-REFERENCE TO THE RELATED APPLICATION

This application claims the benefit of and priority from provisional Application No. 62/938,066, filed on Nov. 20, 2019, the entire content of which is incorporated herein by reference.

### FIELD

Various embodiments described herein relate to methods, devices, and computer program products for learning techniques.

### BACKGROUND

Teaching is an important activity since teachers prepare and influence tomorrow's leaders and workforce. Teachers have an ability to inspire and develop people and thus hold the key to the future success of organizations, corporations, governments, and countries. Effective teaching is important to make use of valuable face-to-face time between the teacher and students. Many effective teaching techniques can be extended to improve communication across a variety of domains including business, medicine, human-resources, and social work. Therefore, tools to assess and improve teaching and communication are needed.

### SUMMARY

Various embodiments of the present inventive concepts are directed towards a method of providing feedback to a participant. The method includes receiving by a transceiver, from an electronic recording device, signals including audio information and/or video information associated with the participant and one or more recipients, determining a first question and/or a first statement provided by the participant based on analyzing the audio information and/or the video information that was received, identifying a second question and/or a second statement provided by the one or more recipients based on the analyzing the audio information and/or the video information, generating an output comprising guidance to the participant based on one or more of the first question, the first statement, the second question, or the second statement, and transmitting the output including the guidance to an electronic device for display to the participant.

According to some embodiments, the method may include identifying one or more persons based on the audio information and/or the video information that was received, and identifying a first person of the one or more persons as the participant and identifying a second person of the one or more persons as a recipient of the one or more recipients. The method may include determining a question type of the first question. The question type may include an open ended question, a content specific question, or a knowledge connection question. Generating the output comprising the guidance to the participant may include determining a check for understanding score based on the second question and/or the second statement from the one or more recipients, and generating the output comprising the guidance to the participant based on the check for understanding score. The method may include determining a question type of the first question. The question type may include an open ended question, a content specific question, a general affirmation question, a classroom logistics question, or a knowledge connection question. The method may include determining a proficiency score and/or a higher order thinking score based on the question type.

According to some embodiments, the check for understanding score may be based on the proficiency score and/or the higher order thinking score. The guidance to the participant may include recommended questions for the participant. The recommended questions for the participant may be based on goals of the participant. The recommended questions for the participant may be further based on progress towards the goals of the participant. The method may include determining respective current scores associated with respective attributes related to the goals of the participant, and determining distances from the respective current scores to respective target scores of the respective attributes. The guidance to the participant may be based on the distances. The method may include prioritizing ones of the attributes based on the distances that were calculated, and determining the guidance to the participant based on the ones of the attributes that were prioritized. The attributes of the participant may include a speaking time to silent time ratio, a question to statement ratio, and/or question types. Prioritizing ones of the attributes may include determining strategy recommendation priorities and/or question recommendation priorities.

According to some embodiments, the method may include generating a list of mentor candidates, and recommending a mentor to the participant. The list of mentor candidates may include a ranked list of mentor candidates based on associating parameters between the participant and the mentor candidates. The ranked list of mentor candidates may be based on historical information related to effectiveness of the mentor candidates. The ranked list of mentor candidates may be further based on goals of the participant and/or the mentor candidates.

According to some embodiments, generating the list of the mentor candidates may include generating a ranked list of mentor candidates based on respective proficiencies of ones of the mentor candidates in one or more attributes related to a goal of the participant. Generating the list of the mentor candidates may include generating a ranked list of mentor candidates based on comparing questioning techniques of the participant and questioning techniques of ones of the mentor candidates.

Various embodiments of the present inventive concepts are directed towards a computer program product. The computer program product includes a tangible, non-transitory computer readable storage medium that includes a computer readable program code embodied therein. The computer readable program code includes computer readable code to receive by a transceiver, from an electronic recording device, signals comprising audio information and/or video information associated with a participant and one or more recipients, computer readable code to determine a first question and/or a first statement provided by the participant based on analyzing the audio information and/or the video information that was received, computer readable code to identify a second question and/or a second statement provided by the one or more recipients based on the analyzing the audio information and/or the video information, computer readable code to generating an output comprising guidance to the participant based on one or more of the first question, the first statement, the second question, or the second statement and computer readable code to transmit the output including the guidance to an electronic device for display to the participant.

Various embodiments of the present inventive concepts are directed towards an electronic device that includes a processor, a transceiver, and a memory coupled to the processor, the memory including computer readable program code embodied therein that, when executed by the processor, causes the processor to perform operations including receiving by the transceiver, from an electronic recording device, signals including audio information and/or video information associated with a participant and one or more recipients, determining a first question and/or a first statement provided by the participant based on analyzing the audio information and/or the video information that was received, identifying a second question and/or a second statement provided by the one or more recipients based on the analyzing the audio information and/or the video information, and an output comprising guidance to the participant based on one or more of the first question, the first statement, the second question, or the second statement, and transmitting the output including the guidance to an electronic device for display to the participant.

Further features, advantages and details of the present inventive concepts will be appreciated by those of ordinary skill in the art from a reading of the figures and the detailed description of the preferred embodiments that follow, such description being merely illustrative of the present inventive concepts.

It is noted that aspects of the inventive concepts described with respect to one embodiment, may be incorporated in a different embodiment although not specifically described relative thereto. That is, all embodiments and/or features of any embodiment can be combined in any way and/or combination. Other operations according to any of the embodiments described herein may also be performed. These and other aspects of the inventive concepts are described in detail in the specification set forth below.

### BRIEF DESCRIPTION OF DRAWINGS

FIG. 1 illustrates the overall application flow for learning assessment techniques, according to various embodiments.

FIGS. 2A and 2B are flowcharts of operations for effective questioning techniques, according to various embodiments.

FIG. 3 is a flowchart of operations for identifying participants, according to various embodiments.

FIGS. 4A and 4B are flowcharts of operations for computing the Check for Understanding Score, according to various embodiments.

FIGS. 5A and 5B are flowcharts of operations related to the Question Recommendation Engine, according to various embodiments.

FIG. 6 is a flowchart of operations related to calculating question and strategy recommendation priority, according to various embodiments.

FIG. 7A is a flowchart of operations related to question generation, according to various embodiments.

FIGS. 7B to 7F are sample reports that may be generated, according to various embodiments.

FIGS. 8A and 8B are flowcharts of operations for automated recommendations for activities and assignments (ARAA), according to various embodiments.

FIG. 9 is a flowchart of operations for synchronizing a classroom session with a learning management system (LMS) lesson plans, according to various embodiments.

FIGS. 10A and 10B are flowcharts of operations for a learning activity recommendation engine, according to various embodiments.

FIG. 11 is a flowchart of operations for a teacher mentor pairing system (TMPS), according to various embodiments.

FIGS. 12A, 12B, and 12C are flowcharts of operations for generating a list of mentor candidates, according to various embodiments.

FIGS. 13A and 13B are flowcharts of operations of a Persuasion Intelligence Engine (PIE), according to various embodiments.

FIG. 14 is a flowchart of operations for calculating the Persuasive Index Score, according to various embodiments.

FIG. 15 is a flowchart of operations for calculating the Persuadability Index Score, according to various embodiments.

FIGS. 16A, 16B, and 16C are flowcharts of operations of the Persuasion Intelligence Engine, according to various embodiments.

FIG. 17 illustrates the overall application flow of the ARAA, according to various embodiments.

FIG. 18 illustrates the overall application flow of the TMPS, according to various embodiments.

FIG. 19 illustrates the overall application flow of the PIE, according to various embodiments.

FIG. 20 is a block diagram of a device for learning management, according to various embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

A teacher and one or more students may be in a learning environment such as a classroom. It may be desirable to assess the effectiveness of a teacher, mentor the teacher, and/or to provide feedback and/or suggestions to the teacher. Various embodiments described herein arise from the recognition that current and/or previous data may be aggregated to provide feedback to the teacher to improve “inquiry learning” or “socrative learning” by analyzing video and/or audio of the learning environment.

Some embodiments of the present inventive concepts are directed to improving a teacher's performance by providing real time guidance about effective questions and questioning techniques that can be used during a teaching session. Effective Questioning Techniques (EQT) will be discussed in detail.

The primary inputs to the system may include real time audio and video streams of a teacher and their students. These inputs may be integrated with data from a learning management system (LMS) and a data store of prior analyzed sessions. The system may perform real time analysis of the incoming data and generate just-in-time guidance (i.e. real time guidance) for the teacher. This guidance may include: (1) recommendations for the types of questions that the teacher may ask, (2) suggestions for adjusting speaking and listening patterns, and/or (3) recommendations for specific content related questions that the teacher may ask during the session. This guidance may be presented via audio/visual feedback on one or more devices in the learning environment. Session data may be archived to generate a history of the teacher's performance that may be analyzed to evaluate the teacher's progression toward teaching goals over time. This data may be aggregated to provide performance measures and/or recommendations across a school, school district, and/or organization.

Real time guidance for effective questioning techniques may have an immediate application in the field of education. The inventive concepts described herein may also be applied to a variety of related situations including sales and customer support in business, counseling and therapy for social-work, treatment and support in medicine, job interviews and human-resources functions across multiple organization types. In other words, a learning environment may extend beyond a classroom into a variety of settings.

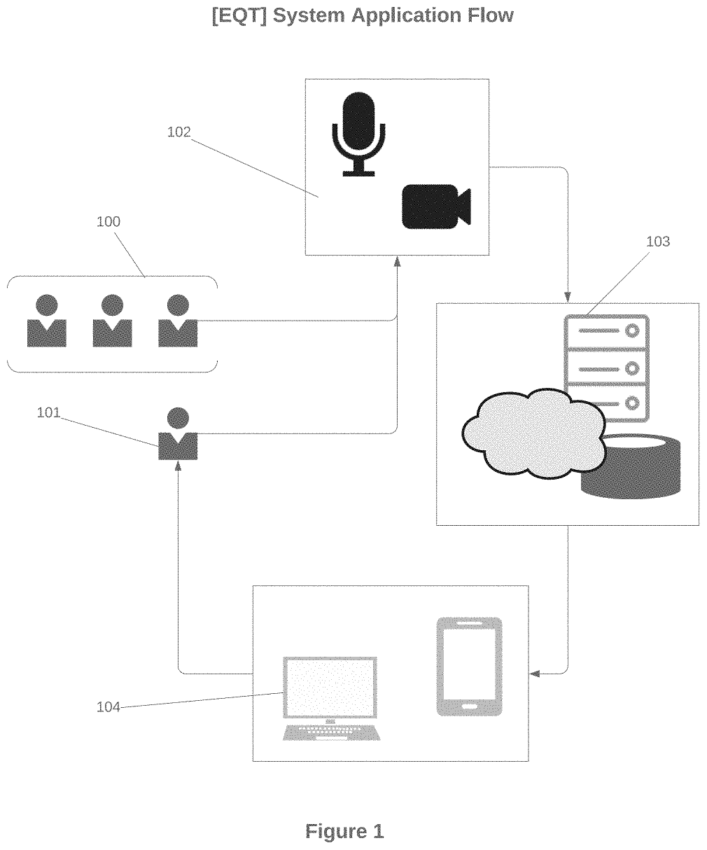

FIG. 1 illustrates the overall application flow. Referring to FIG. 1, students 100 may be participating in learning sessions with a teacher 101. A speaker or participant, such as a teacher, may have access to real time guidance and/or archived reports generated by the system. At block 102, audio devices and/or video devices may capture data representing the learning session by recording the teacher 101 and/or students 100. At block 103, data may be sent to servers or other devices that are remotely located from the learning environment such as in the cloud. Hardware and/or software in the remote location may analyze and/or store the data from the learning environment. In some embodiments, the analysis may be performed on a device that is co-located with the learning environment. At block 104, information based on the data that has been analyzed may be sent to or otherwise accessible by devices and applications (hardware and/or software) that are available to teachers and/or administrators. The guidance may be transmitted to an electronic device for display to the teacher and/or administrators.

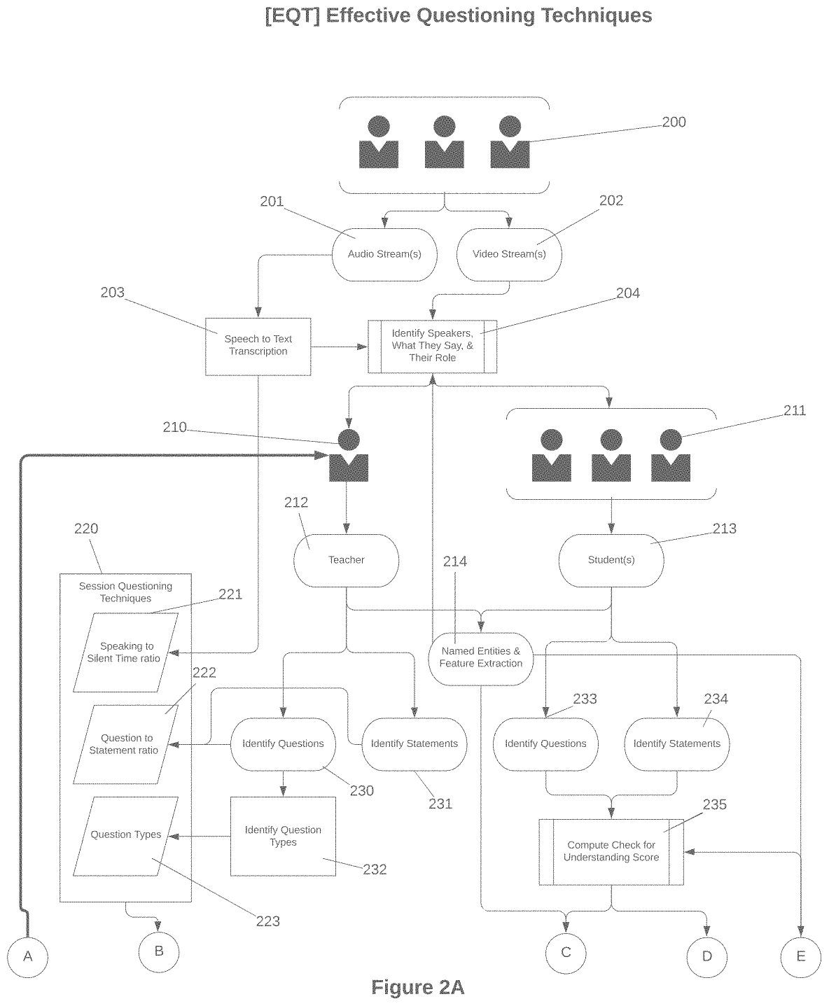

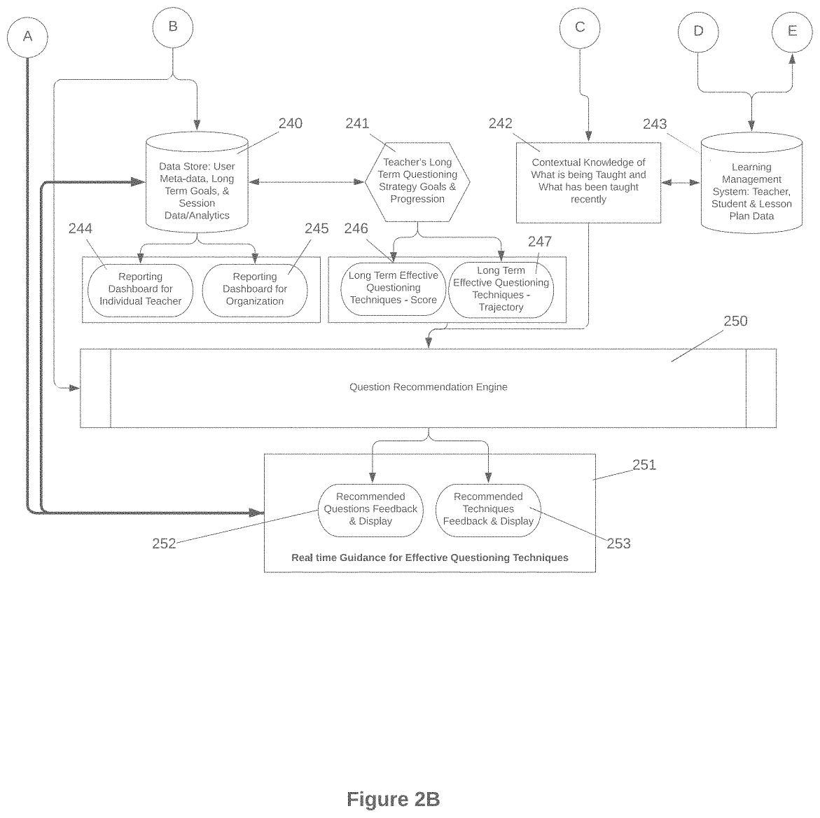

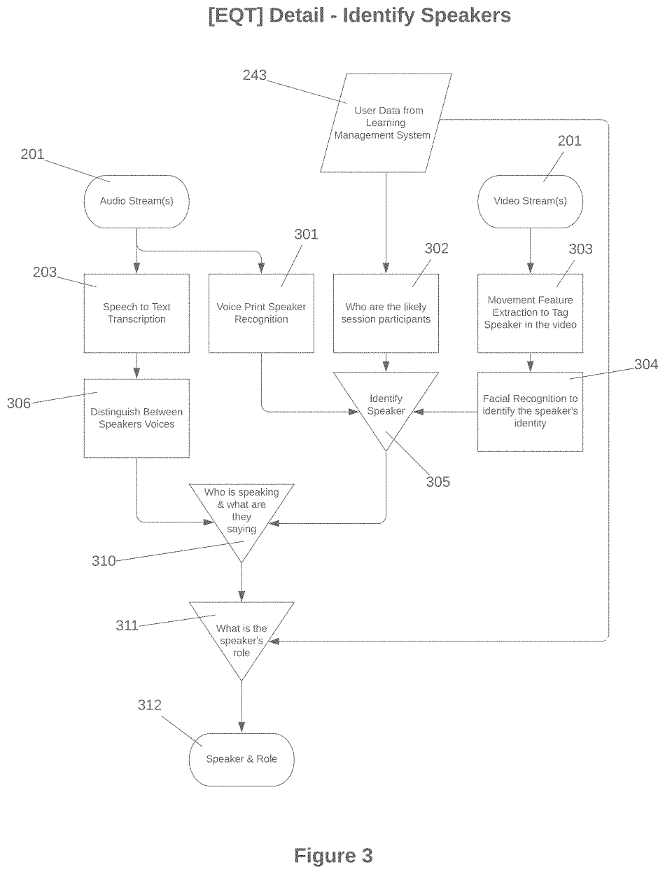

FIGS. 2A, 2B, and 3 are flowcharts of operations for effective questioning techniques. Referring to FIGS. 2A, 2B, and/or 3, one or more persons 200 participate in a teaching and learning session. Real time audio from the session may be captured by a device or multiple devices in the room, to obtain an audio recording stream 201. Real time video from the session may be captured by a device or multiple devices in the room, to obtain a video recording stream 202. Automatic speech recognition may be used to transcribe each speaker's audio into text to provide speech to text transcription, at block 203. Speakers may be identified, as well as what a speaker is saying, and/or the role of the speaker may be identified, at block 204. Current audio and speech transcription technology is capable of distinguishing between different speakers based on voice characteristics alone. However, current technology may not be able to specify the actual identity of each speaker without prior voice recordings and analysis. This is an especially difficult task in large groups (15+ participants), which may correspond to a typical classroom learning situation. In this case, video data and/or a learning management system may be used to accomplish this task by enhancing the speech recognition.

Still referring to FIGS. 2A, 2B, and/or 3, voice print speaker recognition may be performed, at block 301. Audio data about each participant in the session, may be used to identify speakers from the audio stream. This data is processed and provided to identify the speaker. Likely session participants may be identified, at block 302. The system may use data from the LMS to narrow the list of likely session participants. This data may include, but is not limited to, lists of classroom teachers and student rosters. Narrowing the scope of the identity search supports the audio and visual analyses in the system. Movement feature extraction may be performed to tag speakers in the video, at block 303. In most instances, there may be one speaker active during the session. To identify which individual in the room is speaking at a given time, the system may analyze the video to extract movement features. These features include, but are not limited to, (1) hand raising, (2) mouth movements, and/or (3) eye gaze. From these movement features, the speaker at a given time may be determined. Facial recognition may be performed to identify the speaker's identity, at block 304. Facial recognition may be used to analyze the video during time intervals when a speaker is identified. In this way, the system may be able to assign a specific identity to the speaker. The speaker may be identified, at block 305. Data from the LMS may be used to corroborate facial recognition data. The LMS may provide context regarding the likely session participants, which may simplify the facial recognition problem. Who is speaking and/or what the speaker is saying may be determined, at block 310. Timestamped speaker identification data may be merged with timestamped audio transcription data to synthesize who was speaking when, and what were they saying. The Speaker's role may be determined, at block 311. Data from the LMS may be integrated to link identified speakers with their respective roles in the session. For example, a student or teacher may be identified. A teacher 210, 212 may have a specific role in the system, and thus the system may identify and label the speech of a teacher as such. Students 211, 213 may also have a specific role in the system, and thus the system may identify and label the speech of the student as such. Students may be treated individually or as a group of participants. The speaker and their respective role may be determined, at block 312. The analysis of who is speaking and when, is merged with data about their respective role in the session.

Still referring to FIGS. 2A, 2B, and/or 3, named entities and related feature extraction may be performed, at block 214. Keywords, specialized terms, important topics, and/or related terms may be identified and extracted from the teacher's and/or students' speech. Summary statistics that include the presence and frequency of the terms that are used to establish the context of the lesson may be generated. For example, summary statistics may include what topics the lesson covers or if the topic is being introduced or reviewed. Data from the lesson is synchronized with the learning management system (LMS) in a bi-directional fashion. The LMS may supply details about the teacher's curriculum and lesson plans. The features extracted from the lesson may supply data to the LMS about the teacher's progress through their curriculum and/or deviations from the curriculum. Questions from the teacher 212 or students 213 may be identified, at block 230,233. Voice inflection and/or related natural language processing techniques may be used to distinguish questions vs. statements in transcribed speech. Statements from the teacher 212 or students 213 may be identified, at block 231,234. Voice inflection and/or related natural language processing techniques may be used to distinguish questions vs. statements in transcribed speech.

Still referring to FIGS. 2A, 2B, and/or 3, analysis of the speech may be performed. A Check for Understanding Score may be computed, at block 235. The system may analyze student questions and statements to evaluate their understanding of the topic. These real time inputs may be supported by data from the LMS which includes student performance data regarding mastery of academic skills and standards.

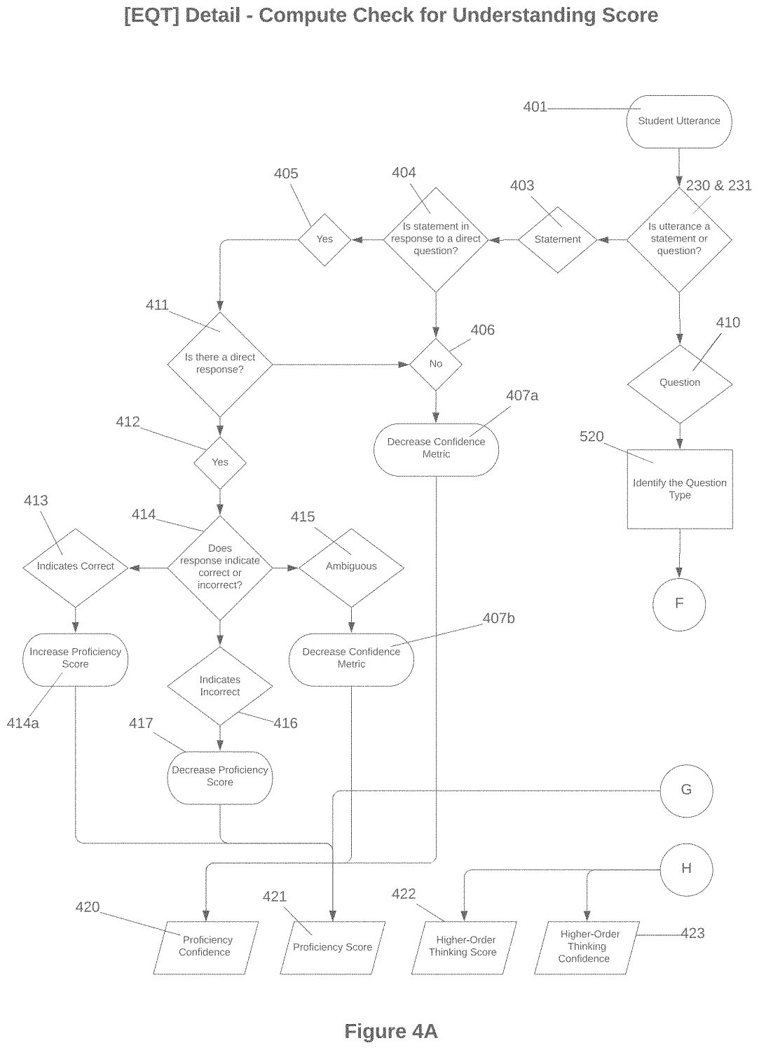

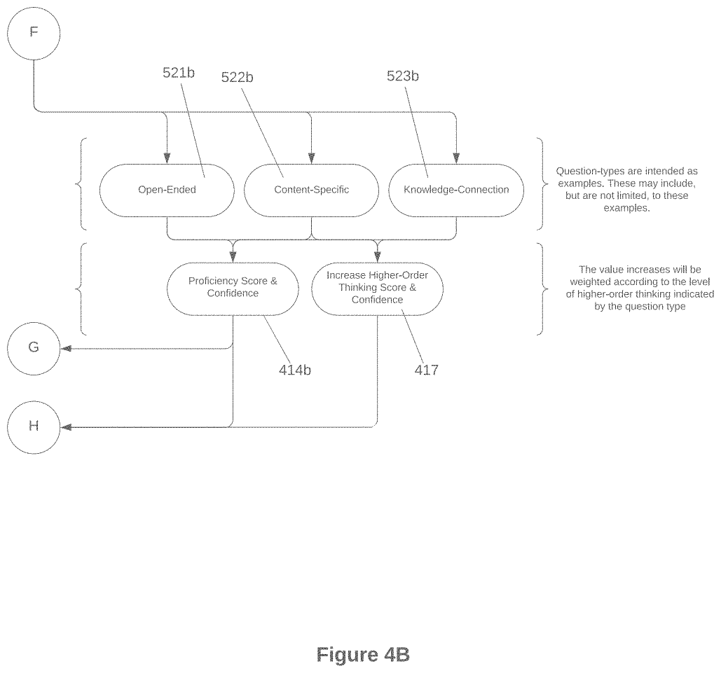

FIG. 4A is a flowchart of operations for computing the Check for Understanding Score. Referring to FIG. 4A, student utterance of words may be analyzed 401. As described above, the system identifies questions and statements from students' classroom interactions.

Still referring to FIG. 4A, questions 410 may be analyzed to extract data about the student's understanding. The Question Type may be identified, at block 223. The question-type may be used to evaluate the student's proficiency and higher-order thinking abilities. For example, the presence of Knowledge-Connection questions indicates higher-order thinking because the student is able to apply their knowledge to other areas of study or other areas of their lives. Referring to FIG. 4B, a Proficiency Score & Confidence 414b may be determined. The presence of specific question types (e.g., Content-Specific) indicates that the student understands the topic and is investigating further. The system increases the proficiency score and confidence values. Referring to FIG. 4A, the Higher-Order Thinking Score and Confidence may be increased, at block 417. The presence of specific question types (e.g., knowledge connections) indicates that the student is able to apply and extend their knowledge of the topic to other areas. The system increases the higher-order thinking score and confidence. Student statements are analyzed in the context of a dialog, at block 403. The system may determine if the statement is in response to a specific question, at block 404. In other words, it may be determined if a teacher or another student asked a question that the student is now answering. If yes, at block 405, is there a direct response, at block 411. Now that the student has answered the question, does a teacher or other student respond directly to the student's statement? If no, at block 406, a decrease confidence Metric may be performed, at block 407a. If the system has ambiguous data, the confidence metric is lowered in response.

Still referring to FIG. 4A, it may be determined if the response indicates a correct or incorrect response, at blocks 412 and 414. A determination may be made if it is evident that the response indicates that the student answered the question correctly or incorrectly. For example, if the student's statement is a correct response to an explicit question, the system would determine a high confidence of the student's proficiency. The response may indicate that the answer was correct, at block 413. For example, “Yes” or “Correct” or “Excellent” may be used to indicate a correct answer. Increase Proficiency Score 414a: The system uses this data to increase the proficiency score. The response may be indicated as being incorrect, at block 416. For example, the response may be “That's not quite right.” In this case, the Proficiency Score may be decreased, at block 417. The system may use this data about an incorrect response to lower the proficiency score. The response may be indicated as being ambiguous, at block 415. It may not be possible to determine from the response if the answer was correct or incorrect. For example, the response may have been “Ok, other ideas?”. In this case, the confidence metric may be decreased, at block 407b. Since the data is ambiguous, the system may lower the confidence score.

The Check for Understanding Score may be based on a Proficiency Score 421, Higher-Order Thinking Score 422, and/or proficiency confidence and higher-order thinking confidence 420, 423. The Proficiency Score 421 may reflect to what extent the student has demonstrated understanding of the topic. The Higher-Order Thinking Score 422 may reflect to what extent the student has demonstrated that they are capable of higher-order thinking related to the topic. Specifically, is the student able to move beyond simple recall of facts, and synthesize different forms of knowledge? Also, is the student able to apply their knowledge in other areas? Proficiency, Confidence, and higher-order thinking confidence 420, 423 is a measure of the system's confidence in the assigned Proficiency Score or Higher-Order Thinking Score. Typically, this indicates if there is sufficient evidence of proficiency or higher-order thinking. For example, if there is little assessment data, the system may not be confident of the student's proficiency. Similar, if the assessment data does not include explicit evidence of higher-order thinking, the system cannot be fully confident in the score.

Referring once again to FIG. 2A, question types may be identified, at block 232. Questions may be extracted from the lesson participants. The questions may be categorized according to the speaker's intent and the predicted types of responses that listeners might have.

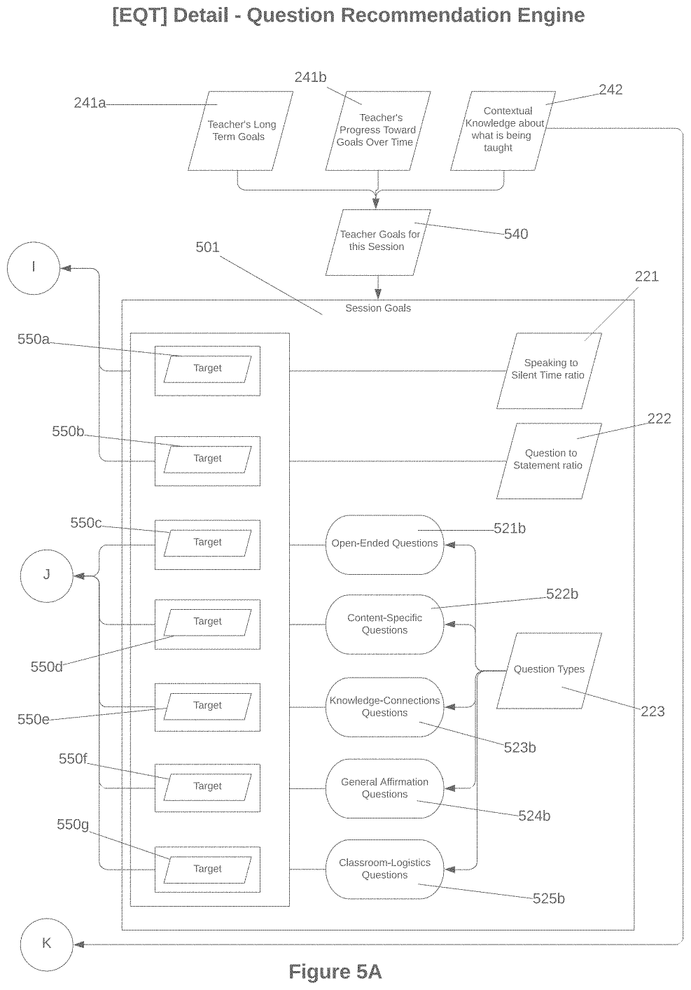

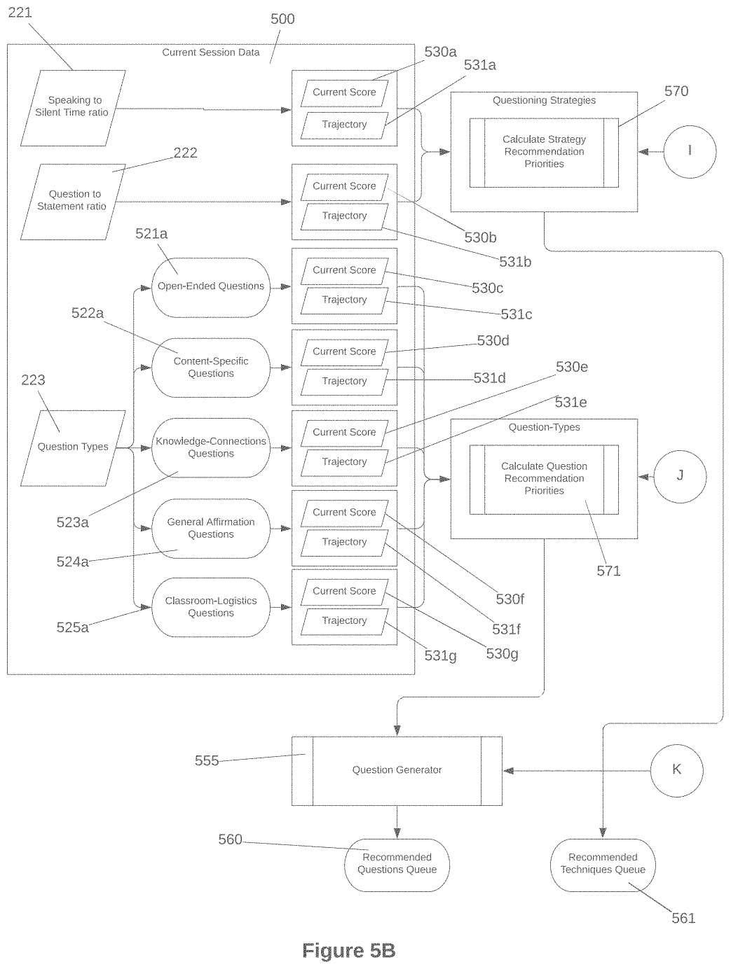

FIG. 4B illustrates example question types. FIGS. 5A and 5B are flowcharts of operations related to the Question Recommendation Engine. Referring to FIGS. 4B, 5A, and/or 5B, example education question types include, but are not limited to, Open-Ended 521a-b, Content-Specific 522a-b, Knowledge-Connection 523a-b, General-Affirmations 524a-b, and/or Classroom-Logistic 525a-b. The Open-Ended question type 521a-b could have a variety of responses, and typically, would not have just one correct answer to the question. Examples: What do you see? How can we test that? The Content-Specific question type 522a-b may make specific reference to something the teacher is teaching. Typically, there may be a correct or incorrect answer to this type of question. Examples: How big is that angle? What is the slope of that line? The Knowledge-Connection question type 523a-b may be asking people to consider how something relates to other events, topics, or people in their lives. Typically, there may not be just one right or wrong answer to this type of question and these questions may occur infrequently. Examples: Have you ever seen this before? How does this relate to your life? Can you think of similar events that we have studied? The General-Affirmations question type 524a-b may be generic question utterances that are not intended to elicit a specific response. Typically, the question may occur at the end of a statement and may be rhetorical. Examples: Okay? That was fun, right? The Classroom-Logistic question type 525a-b may not be related to teaching a topic, and have more to do with managing a group of students. Typically, this question type has to do with getting students to pay attention or get situated in the room. Examples: How are you? Can you sit over there, please?

The system may use natural language processing, machine learning, artificial intelligence, and related techniques to identify question types. Initial training data sets may be generated by human domain experts who are trained to label questions with the correct question-type. This training data may be used as the input to train the machine learning algorithm. After training, the machine learning algorithm will analyze individual questions and output a question-type label. The question-labeling algorithm may improve over time as the training dataset increases in time with each new session. The updated training dataset may be used to retrain and refine the machine learning algorithm at a regular interval. The question-types discussed above are included as specific non-limiting examples to illustrate an application in the field of education. The specific question-types may include but are not limited to these samples. In addition, the specific question-types may be modified to suit the appropriate techniques in related application areas including business, medicine, social-work, and human-resources.

The present inventive concepts may include domain knowledge about the types and definitions of questions that may be critical to successful performance in applications across education, business, medicine, social-work, and human-resources. The initial foundation for this domain knowledge is the relevant research literature. For example, in the field of education, there is prior academic work that demonstrates the value of asking certain types of questions to have a positive impact on teaching and learning. This general domain knowledge may be further personalized and refined through the invention. When a new teacher enters the system, general questions are recommended. Over time, the system monitors performance goals and progress, and may make personalized recommendations that are demonstrated effective for each individual user.

The same process applies to applications in related fields. General domain knowledge from prior academic research may serve as a foundation for question techniques and recommendations. Over time, the system may generate refined and personalized recommendations based on accumulated feedback data about the effectiveness of each recommendation.

Referring once again to FIG. 2A, Session Questioning Techniques 220 may include Speaking to Silent Time Ratio 221, Question to Statement Ratio 222, and Question Types 223. The Speaking to Silent Time Ratio 221 may be based on the overall length of a session and the total duration of speaking time found in the speech transcription, where the system computes a ratio of time that participants are speaking vs. when they are silent. This ratio may be an indicator of a teacher's ability to apply the questioning technique of leaving time for participants to think and respond. The Question to Statement Ratio 222 may be based on the overall number of questions vs. statements found in the speech transcription. The system may compute this ratio across all speakers and/or for each individual in the session. This ratio is an indicator of effective questioning techniques. The Speaking to Silent Time Ratio and Question to Statement Ratio may be used to derive additional features that apply to the session, including, but not limited to the Overall Speaking Rate. Any and/or all of the Session Questioning Techniques data may be used to produce additional visualizations and engineered features, such as, but not limited to timestamped charts depicting the appearance of Questions, Question-Types, and Statements; Variations in the Speaking Rate during a session; and/or Time gaps between Questions or Statements. The Question Types 223 may be identified from a session. The presence and frequency of different question types may be a foundation of the real time guidance the system provides to teachers.

Referring to FIG. 2B, a Data Store 240 may store user meta-data, goals, and/or session data/analytics. Data from each session, each session's participants, and real time guidance may be archived in the Data Store 240. This data may be used to inform the system about participants' progress toward goals over time. This data may be used to identify patterns in questioning techniques in a variety of contexts. This Data Store 240 may serve four purposes. (1) Real time Data Input to the Question Recommendation Engine. (2) Reporting Dashboard for Individual Teacher 244, where an individual teacher may query and visualize their data for current and past sessions, including their progress over time. (3) Reporting Dashboard for Organization 245, where an organization can query and visualize data for all teachers—either individually or aggregated—for current and past sessions, including the progress over time for the organization. These may include, but are not limited to Reports that rank order groups of users by performance, reports that cluster users by performance, and/or reports that rank or cluster users according to grades, subjects, and performance. The Reporting Dashboard for Organization may also include interactive tools for communication between groups of users within and/or across organizations. These groups may include, but are not limited to groups for professional learning communities, and groups for administrative support and coaching. The interactive features for communication may include, but are not limited to, user commenting, user ratings, and/or reacting to data (e.g., Liking a question). (4) Refining and Personalizing Question Recommendations. Over time, the system may collect data about question recommendations and how they have impacted a teacher's subsequent performance. For example, if a particular question is recommended, was it asked by the teacher? If so, does it have a positive impact on the session (e.g., encouraging even more Open-Ended questions later in the session?). These recommendations are stored in the system, linked to performance data, and then used as input data to refine the recommendation weights in the Question Recommendation Engine.

Still referring to FIG. 2B, a Teacher's Long-Term Questioning Strategy Goals and Progression may be determined, at block 241. Teachers may have different goals based on a variety of factors. For example, teachers who are early in their careers might have the goal of simply increasing the frequency of questions over the course of an academic year. More experienced teachers might have specific goals in terms of the ratio of question types in their teaching. These goals are understood in the context of the lesson that may include, but are not limited to, knowledge about the topics that are being taught, the age group of participating students, and if the topics are being introduced or reviewed. These goals may be captured and revised over time. These goals may be used to inform the real time guidance to teachers to ensure it is relevant and useful as a means to improve teaching techniques over time.

Teachers' progression toward their goals may be captured in two, multidimensional indices: Long-Term Effective Questioning Techniques Score 246 and Long-Term Effective Questioning Techniques Trajectory 247. The Long-Term Effective Questioning Techniques Score 246 may be computed for each of the analysis dimensions generated in the most recent session and sessions in a time window of the recent past. This window may be typically 2 to 4 weeks, depending on the frequency of analyzed sessions from that window. The Long-Term Effective Questioning Techniques Trajectory 247 may be computed for each dimension of the statistics generated, and may represent the change over the time window. This window may be typically 1 to 2 years, depending on the frequency of analyzed sessions from that window. This index may show if a teacher's performance is increasing or decreasing along a certain dimension. In some cases, teachers will set a long-term goal of increasing their score along a certain dimension. For example, the teacher may want to ask more Open-Ended questions. However, it might also be desirable to decrease their score along another dimension over time. For example, they might want to ask fewer General-Affirmation questions in order to allow more time for the Open-Ended questions.

The contextual knowledge of what is being taught and what has been taught recently may be determined, at block 242. Context may be an important factor in identifying effective questioning techniques. For example, it may be important to understand the topics that are being taught and if these are being introduced, explored, or reviewed. Different topics, taught in different contexts, may need modifications to questions and questioning techniques.

The Learning Management System (LMS) may include teacher, student, and/or lesson plan data, at block 243. The LMS may store a variety of data about teachers, students, and sessions. For teachers, this includes, but is not limited to their user profile (e.g., name, contact info), grades taught, teaching certifications, and their role within the organization. For students, this includes, but is not limited to their user profile (e.g., name, contact info, age, grade), educational assessment data representing their mastery of academic skills, and data summarizing prior courses and topics studied. Lesson plan data includes, but is not limited to, schedules of which topics will be presented and when, data regarding the academic skills and standards that will be addressed in each session, and instructional materials that support the lesson schedule. The flowcharts of FIGS. 2A and 2B indicates a Learning Management System as a reference for contextual data relevant to the education application. This data warehouse may be substituted with the appropriate data store for related application areas such as a Customer Relationship Management System (business) or a Patient Record System (medicine).

A Question Recommendation Engine 250 may generate outputs based on two primary considerations: Current Session Data 500 and/or Session Goals 501. Current Session Data 500: Real time data about the session, the participants, and questioning techniques and question-types found in the session up to the current time. Referring now to FIG. 5A, Session Goals 501 for each dimension may be computed based on three types of inputs. The Contextual Knowledge about what is being taught, the Teacher's Long-Term Goals and the Teacher's Progress Toward Goals Over Time. These inputs may be used to compute the Teacher's Goals for the Current Session 540. The goals may be computed individually for each questioning technique and question type. The inputs include contextual knowledge about what is being taught, at block 242. The teacher's long-term goals, at block 241a, may include historical data about the teachers' and participants' questioning techniques in past sessions. The teacher may specify goal targets for a window of time. The teacher's progress toward goals over time, at block 241b may be based on performance data over multiple sessions, as discussed above. The system may compute the teacher's trajectory or progress toward those goals. Each questioning technique and question type may have a score and trajectory. The current score 530a-g may be the current value of the attribute, computed from the beginning of the session through the current time. For example, if the total ratio after 15 minutes is 2:1, this value may be assigned as the Speaking to Silent Time Ratio Score. The trajectory 531a-g may be the change over time for the attribute, and may be computed in short time windows from the beginning of the session. These time windows are typically in the range of 5-10 minutes. For example, if the Speaking to Silent Time Ratio for the first 5 minutes was 0.5:1, for the second 5 minutes was 2:1, and for the third 5 minutes was 3:1, the trajectory is in the positive direction.

Still referring to FIG. 5B, the current session data may capture the current score 530 and session trajectory 531 for each attribute. These data may be used to predict the projected final score 600 of the attribute for the entire session. Referring to FIG. 5A, the session goals may include a target score 550a-g for each attribute. This target score 500a-g may be the desired value for the attribute at the end of the entire session. The target score is calculated in order to incrementally help the teacher to progress toward long-term goals. The target score for the session is calculated based on the recent index scores for the attribute in recent sessions, and along a trajectory toward the long-term goal.

Referring to FIG. 5B, strategy recommendation priorities may be determined, at 570. This calculation may relate to questioning strategies that a teacher might employ. It may be calculated based on the distance between the Projected Final Score and the Target Score for the session. If the teacher is on track to meet the target, the attribute may not have a priority in the recommendation output queue. However, if the user is not on track, the attribute may be given a priority based on how far off track they are. This priority is further refined based on the extent to which the guidance has yielded positive outcomes in the past. If the recommendation has been successful, the system is more likely to make this specific recommendation. If the recommendation has not been as successful, the system is less likely to make this recommendation.

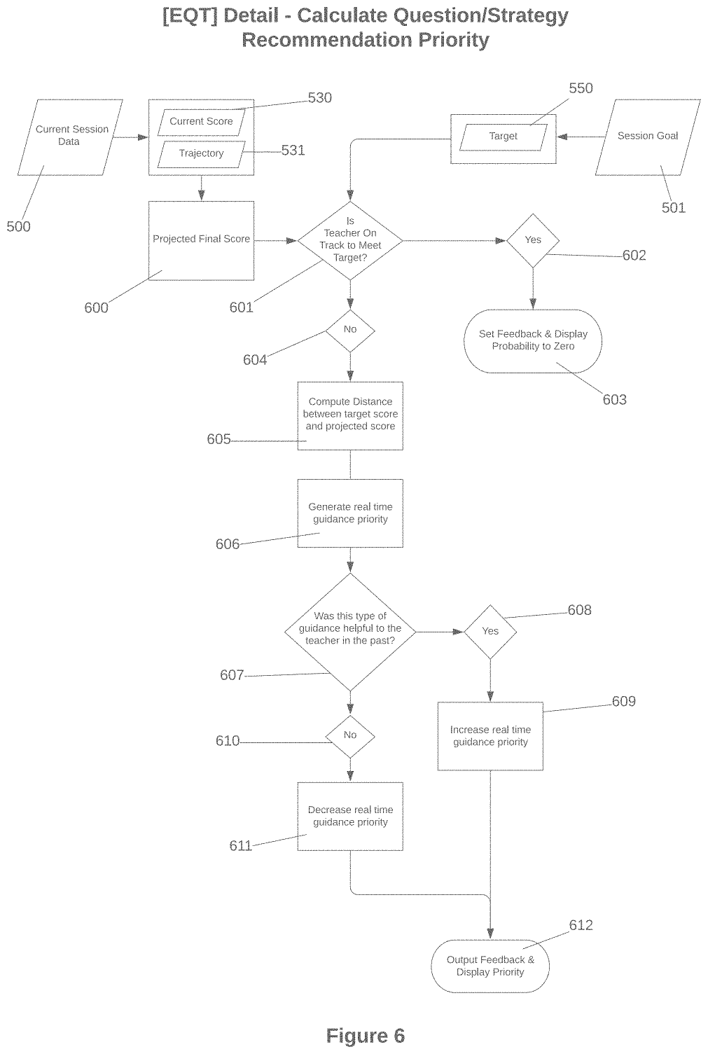

FIG. 6 is a flowchart of operations related to calculating question and strategy recommendation priority. Referring to FIG. 6, it may be determined if the teacher is on track to meet the target, at block 601. The Projected Final Score may be compared with the Session Target to determine if the goal is likely to be met. If the session target is likely to be met, at block 602, the feedback and display probability may be set to zero, at block 603. If the teacher is on track, there may be no need to intervene for this technique. If the session target is not on track to be met, at block 604, a distance between target score and the projected score may be computed, at block 605. This process determines how far away the teacher is from reaching their target. Real time guidance priority may be generated at block 606 based on how far the teacher is from reaching their target, to increase or decrease the priority for offering guidance based on this technique or question-type. At block 607, it may be determined if this type of guidance was helpful to the teacher in the past by drawing from the Database of past sessions and recommendations to determine if it helped the teacher to reach their target when a recommendation was made for this technique or question type. If guidance was helpful in the past, at block 608, the real time guidance priority may be increased, at block 609. If guidance was not helpful in the past, at block 610, the real time guidance priority may be decreased, at block 611. The feedback and display priority may be output, at block 612. At the end of the calculation, the system may have a priority assigned for this technique or question-type. This priority may be fed into the priority-rank queue of recommendations.

Referring again to FIG. 5B, question recommendation priorities may be calculated, at block 571. This calculation may relate to recommendations of questions that a teacher might ask. Similar to the Strategy Recommendations, it may be calculated based on the distance between the Projected Final Score and the Target Score for the session. A question generator 555 may be capable of generating questions that are relevant to the topic and/or needs of the session.

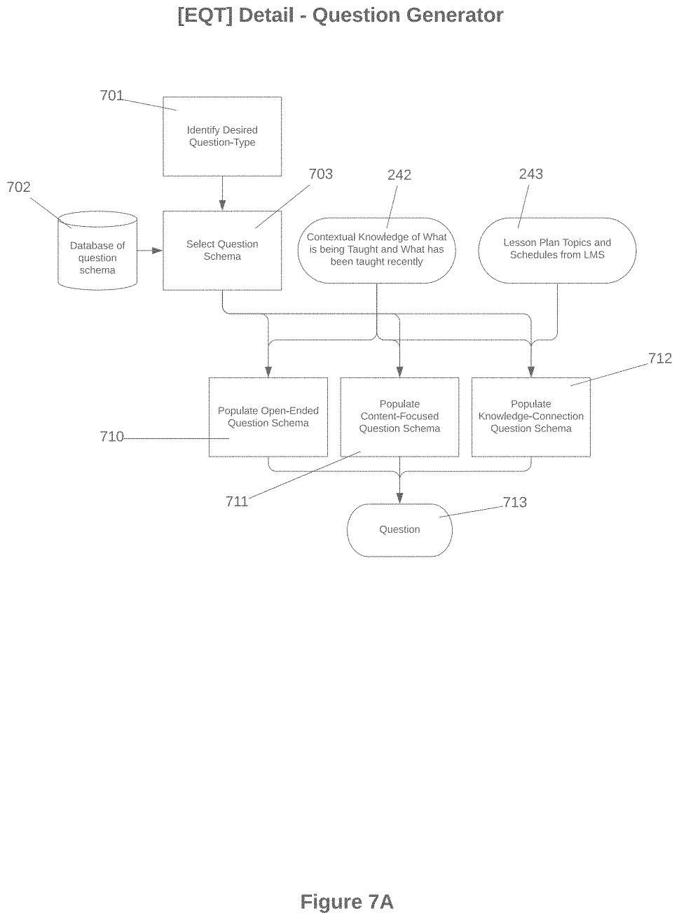

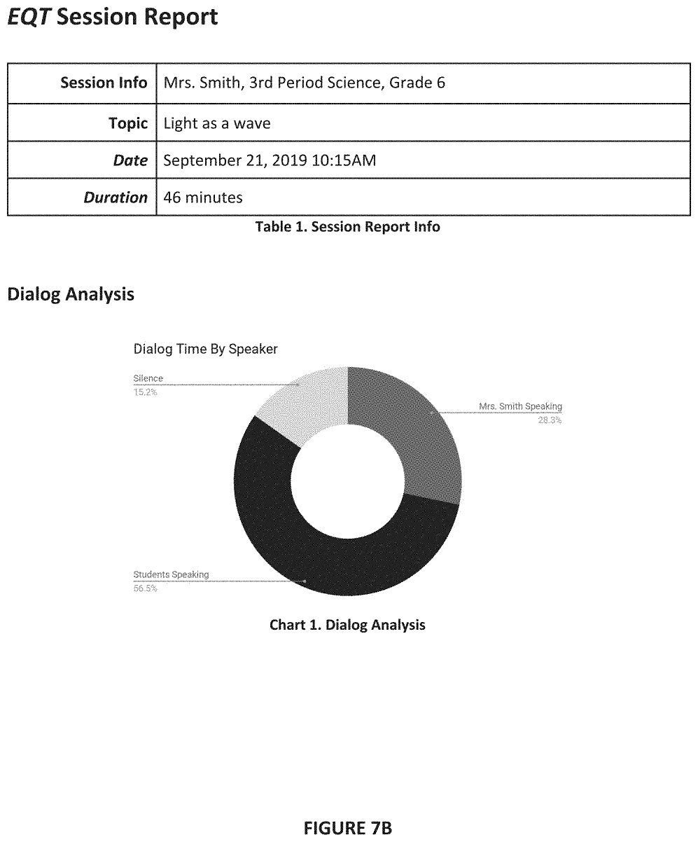

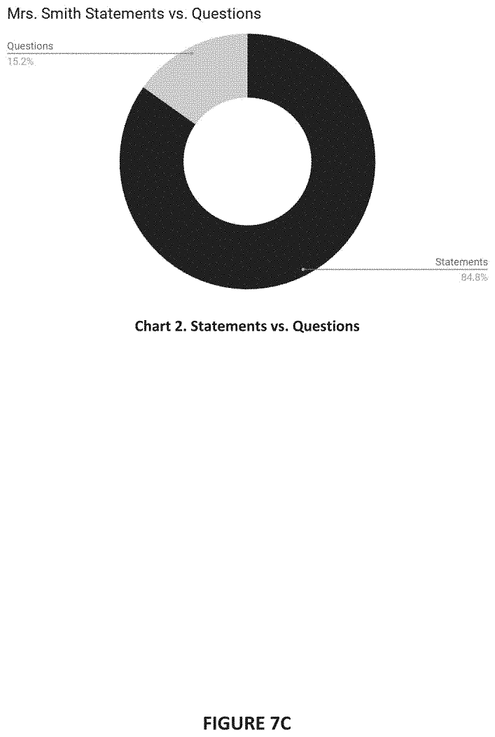

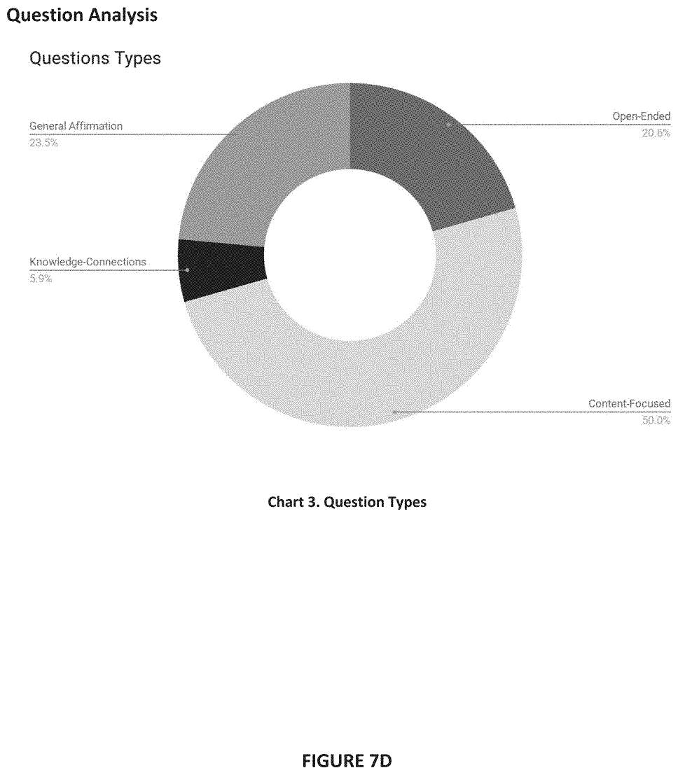

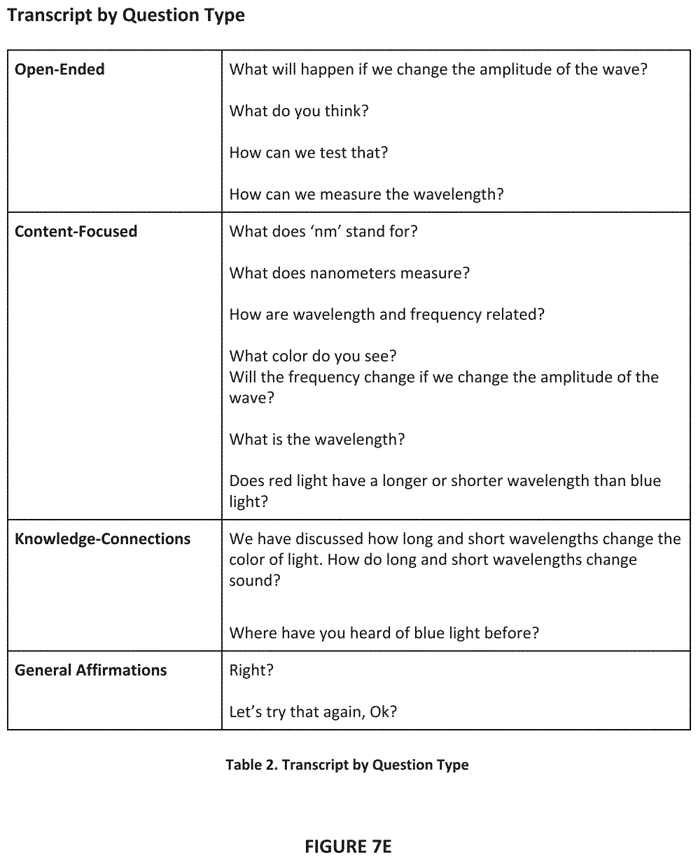

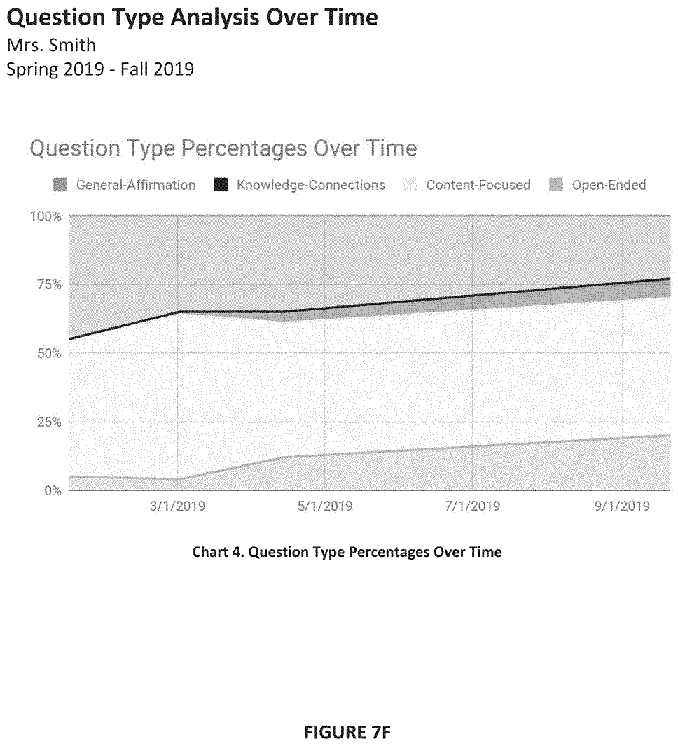

FIG. 7 is a flowchart of operations related to question generation. Referring to FIG. 7, the desired question type may be identified, at block 701. Depending on the score and trajectory values for a given session, the system can generate different types of questions. The system uses a question-type selection algorithm to prioritize question-types that will increase the question-type score within the session. For example, if the teacher is on target with Knowledge-Connection questions, but falling behind in Open-Ended questions, the system will likely identify Open-Ended as the desired question type. Question schema may be selected, at block 703. Based on the identified question-type, the system may obtain information from a database of question schema 702. This database of question schema 702 may continue to grow and improve over time. Specifically, as the system identifies successful questions from real world sessions, those question schemas will be added to the database for later use. Depending on the question type, these questions may be dynamically generated in different ways. For example, open-ended question schema may be populated, at block 710. These may be drawn from a database of known effective questions. Questions may be selected based on the teacher's known question-type patterns, and question schema are populated with relevant topics in real time. Example open-ended questions are “Tell me what you see?” “What is another way we can get the same answer?” Content-specific question schema may be populated, at block 711. These are dynamically generated based on data derived from the Known Entities and Related Feature Extraction module, and the LMS. The system may store a database of question schemas. A schema may be first selected based on the teacher's question-type patterns. The system then populates the schema with appropriate keywords and actions based on the current topics and students' age range. For example, the following sentence scheme may indicate an omission with ****. Example insertion keywords are noted in brackets.

What is the square root of ****? [4]
How many **** does an insect have? [body segments]

Still referring to FIG. 7A, knowledge-connections question schema may be populated, at block 712. These may be dynamically generated by populating pre-constructed question schema with relevant topics and time references. The relevant topics may be derived from the Known Entities and Related Feature Extraction module, and the LMS. The LMS may provide data regarding prior sessions when the same or related topics were addressed with the participants. For example, the following sentence schemes indicate an omission with ****. Example insertion keywords are noted in brackets.

How does this relate to **** that we studied last ****? [animals, week]
How does this relate to the research on **** that we completed last ****? [states of matter, month]
Once the question schema is populated, the system outputs a complete question 713 that can be integrated into the real time feedback.

The recommendation engine may continuously update two types of data that can be used by the teacher during the session. This output is noted as Real time Guidance for Effective Questioning Techniques 251 in FIG. 2B. Referring to FIG. 5B, there may be two types of outputs: Recommended Questions Queue 560 and Recommended Techniques Queue 561. The Recommended Questions Queue 560 is a prioritized list of recommended questions that the teacher can use immediately during the session. This list is updated in real time as the session progresses: Example questions include, but are not limited to: What do you see? How can we test that? Does anyone have another idea? How many planets are there in our solar system? How many items are left if we take away 2? The Recommended Techniques Queue 561 is a prioritized list of recommended techniques. These recommendations may include, but are not limited to items such as: (1) Try leaving more time for students to respond after you ask a question. (2) Try more open-ended questions to get students talking. (3) Don't forget to connect this topic to last week's lessons.

Referring to FIG. 2B, the real time guidance for effective questioning techniques, at block 251, may be a list of recommendations that are presented to the teacher via multiple devices and display types. This includes, but is not limited to, visual display via a dedicated application or widget, visual display embedded in a 3rd party hardware and/or software application, or audio delivery via an audio device. Visual displays can be rendered via any manner of handheld, desktop, augmented reality, or other platform. Recommended questions feedback and display, at block 252, may include recommendations for specific questions to ask. Recommended techniques feedback and display, at block 253, may include recommendations for techniques that the teacher can use.

FIGS. 7B to 7F are sample reports that may be generated. The EQT Session Report in FIGS. 7B to 7F illustrates the type of analysis data that is provided to teachers for a given session. The tables and charts document a single session from example user ‘Mrs. Smith’. Table 1 of FIG. 7B is Session Report Info. This report includes session data including the teacher, date and time, session name, and duration. Chart 1 of FIG. 7B provides dialog analysis to aide in visualizing the speaking vs. silent time ratio. Chart 2 of FIG. 7C illustrates statements vs. questions in order to visualize the statements vs. questions ratio. Chart 3 of FIG. 7D illustrates question types to visualize the proportion of different question-types extracted from the session. Table 2 of FIG. 7E provides a transcript by question type. This table includes the text of transcribed questions from the session. The questions are grouped by question type to match Chart 3 of FIG. 7D. Chart 4 of FIG. 7F provides question type percentages over time in order to visualize the long-term progression of question-types extracted from multiple sessions. This chart illustrates how the teacher has increased the proportion of Open-Ended questions (bottom area of the chart) over time. The chart documents four sessions for the hypothetical time window spanning Mar. 1, 2019 through Sep. 1, 2019.

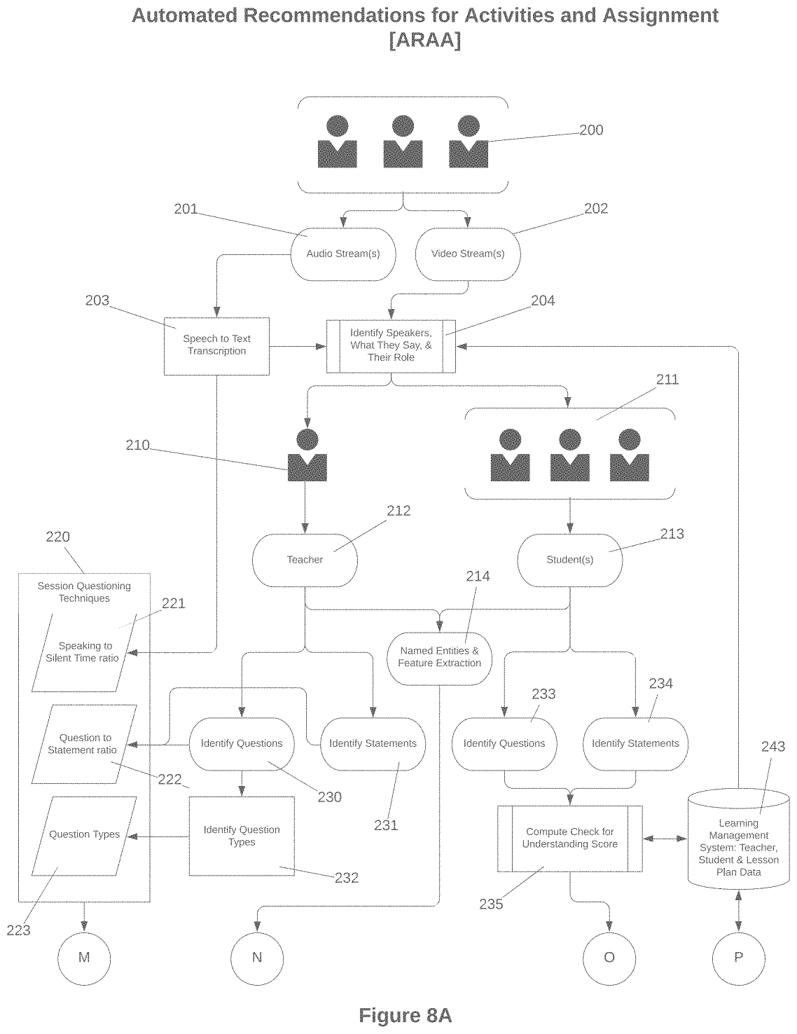

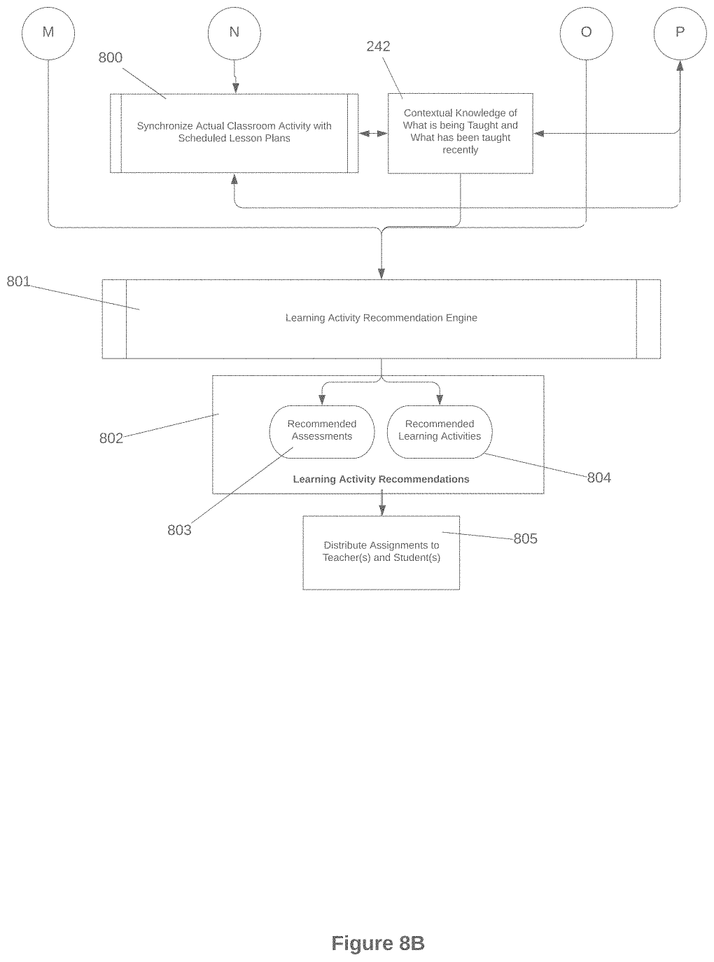

FIGS. 8A and 8B are flowcharts of operations for automated recommendations for activities and assignments [ARAA]. The system may assist a teacher in generating personalized assignments, learning activities, and interventions based on the content of verbal classroom instruction. Legacy Learning Management Systems may analyze student performance and deliver personalized recommendations for students. However, these legacy systems may fail when they are out of sync with the actual lessons that the teacher is delivering in a given session. This can be a common occurrence for a variety of reasons, including that different groups of students may require more or less instructional time for a given topic. This synchronization problem leads to unwanted drift between the classroom and the recommendation system. According to various embodiments described herein, an analysis of what the teacher is actually delivering during classroom instruction is integrated with a LMS or similar digital system. Three aspects of the present inventive concepts will be discussed.

1. Analyzing the actual content of a classroom learning session in order to maintain synchronization between classroom lessons and content housed in a Learning Management System. It is common for teachers to drift from a pre-planned schedule, and the system can adjust for these deviations.
2. Using data from a classroom learning experience to check for student understanding of a topic in ways that cannot be assessed within a digital system. This in-class check for understanding is automatically computed and integrated with LMS assessment data to generate a composite check for understanding. Furthermore, the system recommends different types of assessments to probe for students' higher-order thinking skills around a topic.
3. Matching the teacher's classroom and presentation style to the activity and assessment recommendation engine. For example, if a teacher is asking a number of open-ended questions to drive students' learning toward a deeper exploration of a topic, the system may identify this approach and recommend open-ended writing and research activities. Conversely, if the teacher is using content-specific questioning, the system may adapt to that style and recommend multiple-choice quizzes.

The primary inputs to the system include real time audio and/or video streams of a teacher and their students. These inputs may be integrated with data from a learning management system and a data store of prior analyzed sessions. The system may perform real time analysis of the incoming data to extract features including: (1) one or more on-subject topics discussed in the lesson. (these topics may be directly related to topics that appear at some point in the LMS lesson schedule), (2) one or more off-subject topics that were introduced or discussed (these topics may be relevant to teaching and learning, but cannot necessarily be matched to specific topics in the LMS lesson schedule), and/or (3) one or more difficult topics from the lesson (these are topics that students struggle to understand during the session, and they can be either on-subject or off-subject). These extracted features may be used to synchronize the teacher's delivered lesson with their curriculum. The system may retrieve relevant learning objects from a learning management system that warehouses a variety of learning objects. A learning object may take multiple forms, including but not limited to digital videos, interactive learning activities, worksheets, research projects, essay writing assignments, practice problems, or reading assignments. The system may deliver recommendations in a summary format that the teacher may immediately deliver to students and/or that students can access directly. All session data may be archived to the learning management system to influence future recommendations based on the generated content and the teacher's progression through a curriculum.

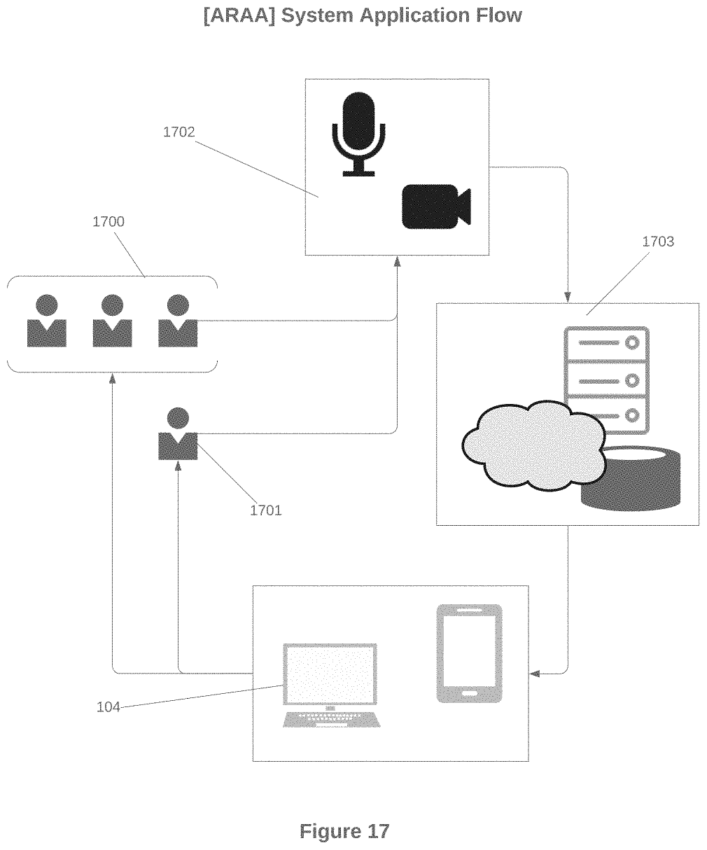

FIG. 17 illustrates the overall application flow. Referring now to FIG. 17, teacher 1701 and students 1700 participate in learning sessions, and access recommended learning activities and assessments generated by the system. Audio and video devices may capture the session, at block 1702. Data may be sent to the cloud where hardware and/or software analyzes and stores the data, at block 1703. Analyzed data may be sent to devices and applications where it can be rendered for teachers and students to provide guidance for improved interaction, at block 104.

Referring now to FIG. 8B, actual classroom activity may be synchronized with scheduled lesson plans, at block 800. The system may solve a critical problem in curriculum delivery. For a variety of reasons, teachers routinely deviate from their predefined lesson schedules. This drift creates additional work to maintain sync between in-person lessons and the LMS.

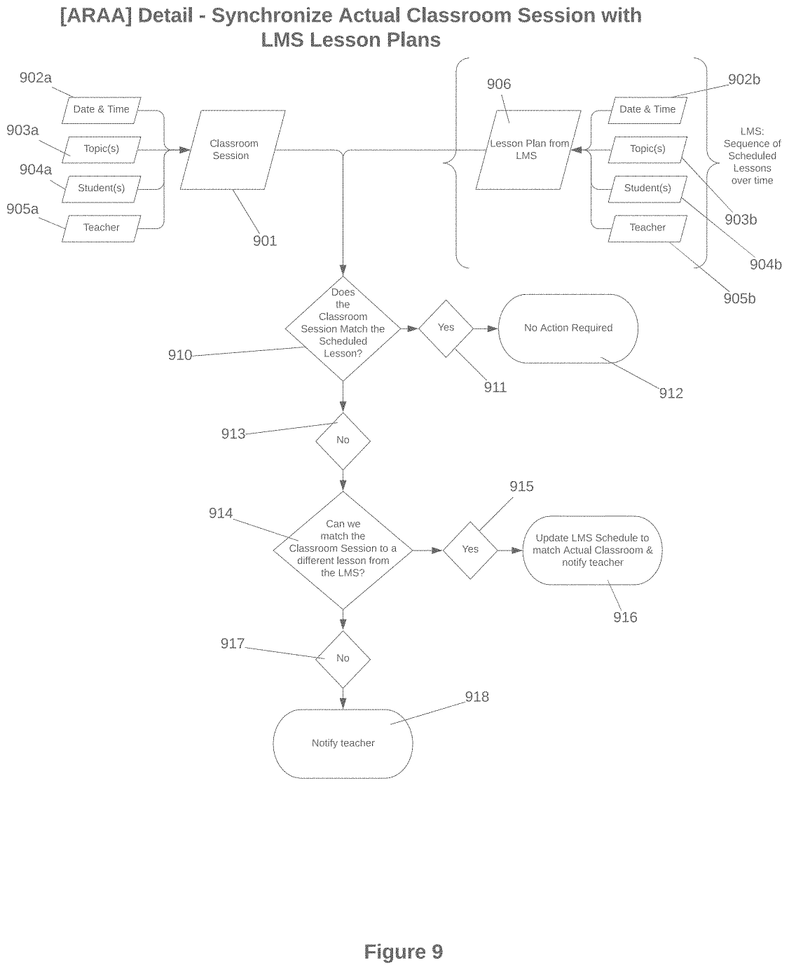

FIG. 9 is a flowchart of operations for synchronizing a classroom session with LMS lesson plans. Referring to FIG. 9, classroom session data may be obtained, at block 901. Using hardware and/or software components described above, the system may analyze audio and/or video streams from a learning session to extract key features. These features may include date and time 902a of the session, learning topics 903a that were discussed during the session, identities of participating students 904a, and/or identifying the participating teachers 905a. The lesson plan may be obtained from the LMS, at block 906. The LMS may store a schedule of lesson plans, class rosters, and/or teacher information. Each lesson plan may include a list of the topics 903b to be discussed along with the date and time 902b of the lesson, list of teachers 905b and/or the Student 904b roster.

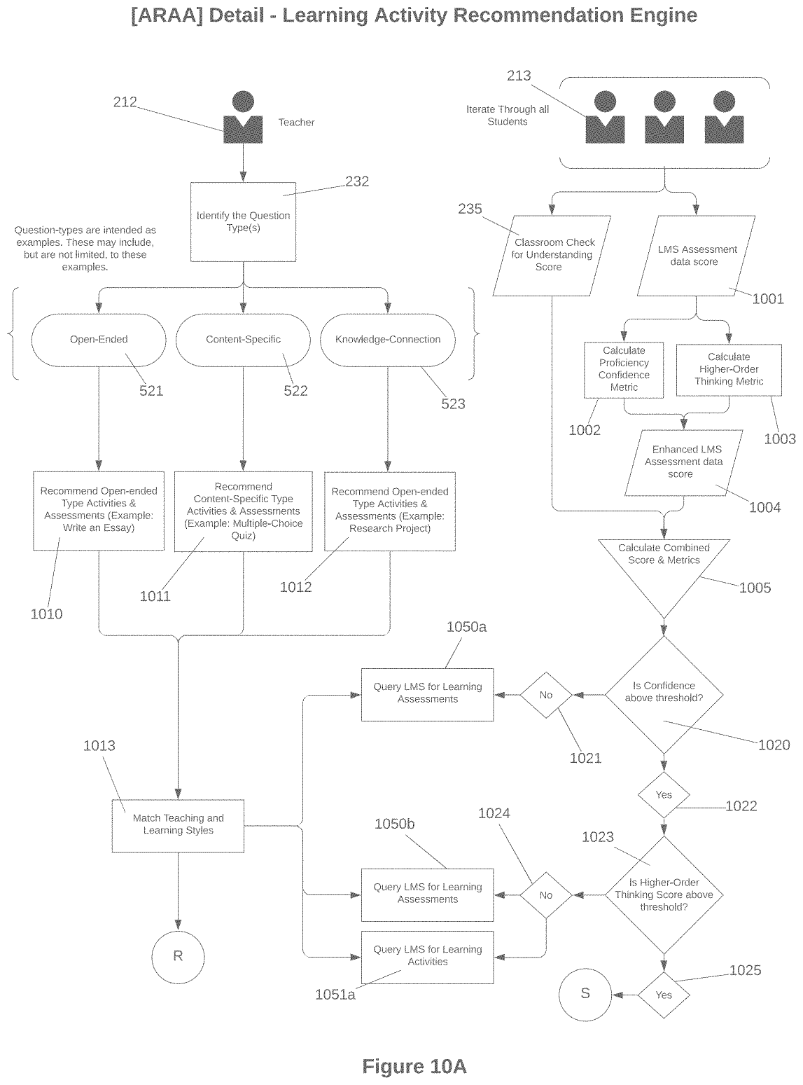

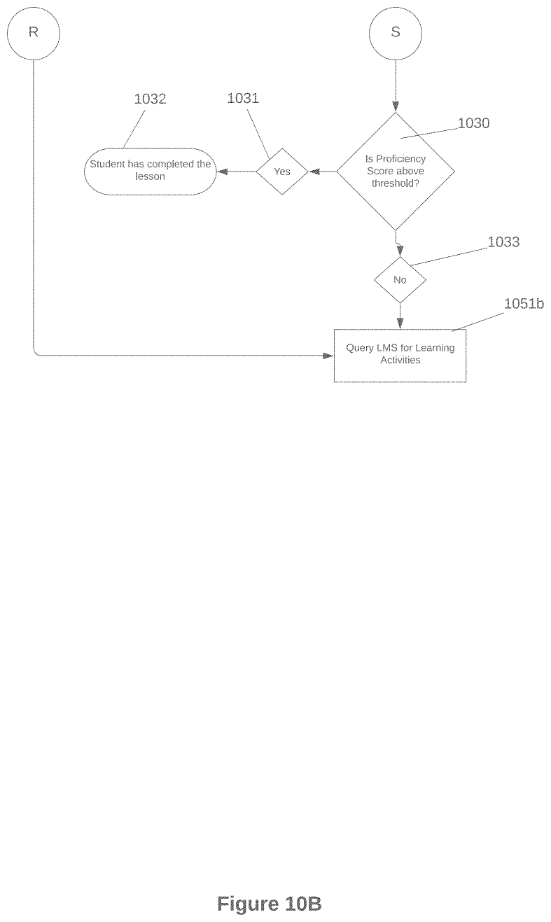

FIGS. 10A and 10B are flowcharts of operations for a Learning Activity Recommendation Engine. Referring to FIG. 10A, the LMS may be queried for related learning activities, at block 1050a-b. The LMS may be queried for related learning assessments, at block 1051a-b. Referring again to FIG. 9, based on the analysis of topics covered in the actual classroom, the system may determine if the classroom session matches the schedule lesson, at block 910. The system analyzes the topics discussed during the classroom session against the topics that are indicated for that date and time in the LMS. If the classroom session matches the schedule lesson, at block 911, the actual classroom is in sync with the schedule of lessons, so no action is required, at block 912. If the classroom session does not match the schedule lesson, at block 913, the system will seek to match the classroom to the correct lesson from the LMS. It may be determined if the classroom session may be matched to a different lesson from the LMS, at block 914. The system may scan forward and backward in time, querying the LMS for potentially matching lesson plans. Each potential match may be rated with a matching score and confidence value to select the best fit. If the system can match to a prior or future lesson plan (on-subject topic), at block 915, the LMS schedule is updated to match actual classroom and a notification may be sent to the teacher, at block 916. The LMS lesson schedule is updated and notifications may be sent. If the system cannot find a match in the LMS (off-subject topic), at block 917, detailed notifications to alert the teacher and/or other stakeholders may be sent, at block 918.

Referring once again to FIG. 8B, the Learning Activity Recommendation Engine 801 will be discussed. This component integrates data from the classroom learning session with the LMS to generate a set of recommended activities and assessments that are personalized to individual students. The recommended activities and assessments may be matched to the teaching and learning styles that are evident in the classroom. Referring to FIG. 2, the teacher 212 may identify the question type, at block 232. The question types may be used to broadly identify the teaching and learning styles that are evident in the classroom. For example, if the teacher is asking a high ratio of Open-Ended questions, this may indicate that students are expected to articulate their knowledge of the topic in their own words. (e.g., Can you explain why this happened?) This indicator may be later used as an input to the match teaching and learning styles 1013 process of FIG. 10A. For example, if the system queries the LMS for a learning activity, open-ended activities such as essay writing and research projects that match the classroom learning style may be prioritized. As another example, the system might find that the teacher is asking a high ratio of Content-Specific questions. (e.g.—What is 2+4? What is the slope of the line?). In this case, the match teaching and learning styles process may prioritize assessments and activities that focus on recall and retention of data such as multiple-choice quizzes and games. The process described may be iterated through students 213. The process may iterate through each student in the session to generate a classroom check for understanding score, at block 235 as described above.

According to some embodiments, the system may aggregate student assessment data from the LMS to generate an assessment score. The system may calculate two values: the proficiency confidence metric 1002 and the proficiency confidence metric 420. The proficiency confidence metric 1002 may be conceptually similar to the Proficiency Confidence Metric 420. However, proficiency confidence metric 1002 may be obtained by analyzing assessment data from the LMS to compute the metrics. The higher-order thinking metric 1003 may be conceptually similar to the higher-order thinking metric 422. However, the higher-order thinking metric 1003 may be determined by analyzing assessment data from the LMS to compute the metric.

The enhanced LMS assessment data score 1004 of FIG. 10A may be the integration of the proficiency score from the LMS plus a confidence metric, and/or a higher-order thinking metric that is inferred from the LMS data. Conceptually, these metrics may be analogous to the confidence and higher-order thinking metrics in the classroom check for understanding score. Practically, these may be calculated based on the types of assessment data and/or student responses that are housed in the LMS. For example, if the LMS includes multiple-choice assessment items for a student, the system may calculate a high confidence metric. Multiple-choice data typically provides an unambiguous view of students' knowledge of a topic and the student's ability to recall and retain information. However, multiple-choice data is often less valuable in providing evidence of students' higher-order thinking. Thus, the higher-order thinking metric would be relatively low in this case, not because the student is not necessarily capable, but because there is insufficient assessment data to make an accurate determination. More assessment data may be required to obtain a better estimation of the higher-order thinking metric. The system may include annotations of LMS assessment and learning activities according to the extent to which they provide evidence of higher-order thinking.

According to some embodiments, the combined score and metrics 1005 may be determined by combining the classroom check for understanding score 235 and the enhanced LMS assessment data score 1004 to generate a composite score. It may be determined if the confidence is above a threshold, at block 1020. If the confidence is not above a threshold, at block 1021, the LMS for learning assessments may be queried, at block 1050a-b. If the confidence is low, the system may recommend gathering additional assessment data for the student by querying the LMS for related learning assessments. If the confidence is above a threshold, at block 1022, then it may be determined if the higher-order thinking score is above a threshold, at block 1023. If the higher-order thinking score is not above the threshold, at block 1024, then the LMS for learning assessments may be queried, at block 1050b. If the Higher-Order Thinking Score is low, the system may recommend gathering additional assessment data if there is insufficient assessment data as described above. The querying of the LMS for learning activities 1051a may include recommending additional Learning Activities that will help students to further their understanding of the topic while improving their higher-order thinking skills. If the Higher-Order Thinking Score is above the threshold, at block 1025, a check may be conducted as to whether the proficiency score is above the threshold 1030, of FIG. 10B. If the Higher-Order Thinking Score is above the threshold, additional assessments or activities do not need to be gathered, and the student is determined to have completed the lesson, at block 1032. If the student has completed the lesson, at block 1032, and/or if proficiency is also adequate, nothing further is required from the student. If the proficiency score is not above the threshold, at block 1033, then LMS may be queried for learning activities, at block 1051b. If the score is low overall, the system may recommend additional learning activities to help students deepen their understanding of the topic.

Additionally, the learning activity recommendations 802 of FIG. 8B may generate recommended assessments and activities that are personalized to individual students and suited to the teacher's classroom style. The recommendations may include recommended assessments 803 and/or recommended learning activities 804. The recommended assessments and activities may be distributed to teachers and/or students, at block 805, through a variety of techniques that may include, but are not limited to: updates to the LMS, direct notifications via email, text, or other channels, teacher dashboards and/or student dashboards.

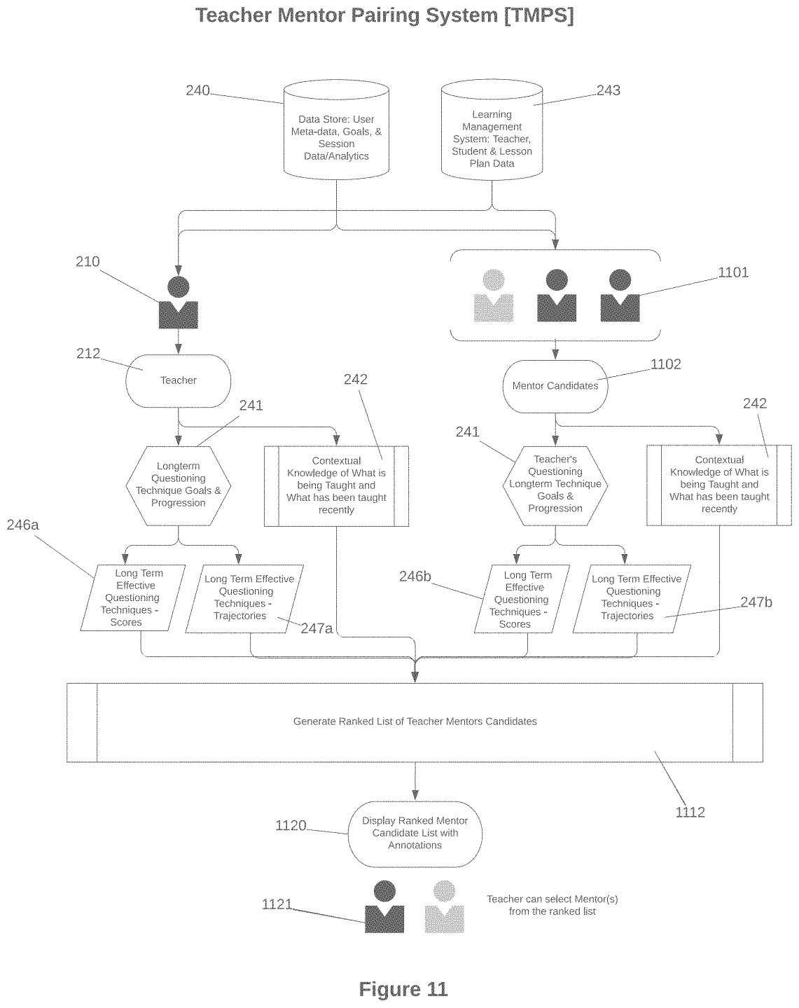

FIG. 11 is a flowchart of operations for a teacher mentor pairing system (TMPS). The aim of the TMPS is to match teachers with appropriate mentors to improve teachers' ability to deliver high-quality instruction through effective questioning techniques. The TMPS may use audio and/or video analysis tools to generate an analysis of questioning techniques. This architecture is similar to the architecture described with respect to FIG. 2. These sessions may be archived over time to create a history and trajectory for the teacher. Based on these data and the teacher's stated goals, the TMPS may identify an appropriate teacher-mentor pairing. The TMPS may take care to match teachers according to their relative skill levels and goals to secure a match that will be complementary and beneficial to both participants.

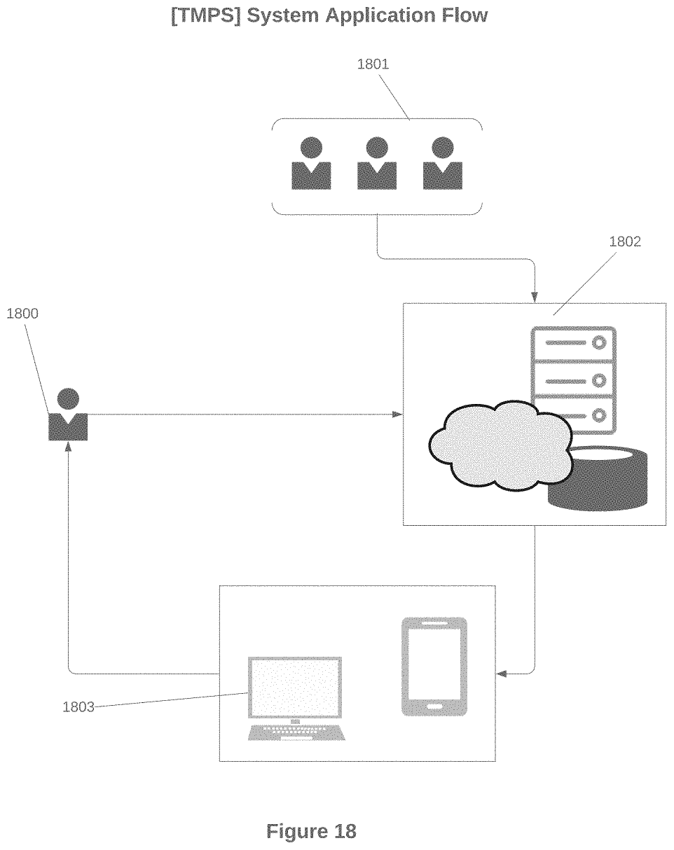

FIG. 18 illustrates the overall application flow of the TMPS. Referring to FIG. 18, teacher 1800 may search for mentors 1801 based on his or her profile of performance and goals regarding Effective Questioning Techniques. Teacher 1800 may access the list of recommended mentors 1801 that is generated by the TMPS. A pool of Mentor Candidates may be stored in a database with profiles of their performance and goals regarding Effective Questioning Techniques, at block 1801. The Mentor Search hardware and/or software may analyze and/or archive the data in the cloud, at block 1802. The analyzed data is sent to devices and applications, at block 1803. The analyzed data may be displayed and/or guidance may be provided based on the analyzed data.

Referring to FIG. 11, mentor candidates 1101, 1102 may be drawn from the database of users. Questioning techniques performance and goals may be stored for each candidate in the database. Additional user data may be provided by the LMS as described above. The TMPS may generate a ranked list of teacher mentor candidates 1112. The TMPS relies upon a database of teacher data including detailed analysis of users' effective questioning techniques. This may include data about teachers' scores, trajectories, goals, and/or long-term progress toward those goals. These TMPS components are described above. The TMPS may also rely upon LMS data to further inform the ranking process. To generate a list of mentor candidates 1101, the TMPS may generate a ranked set of mentor candidates from the pool.

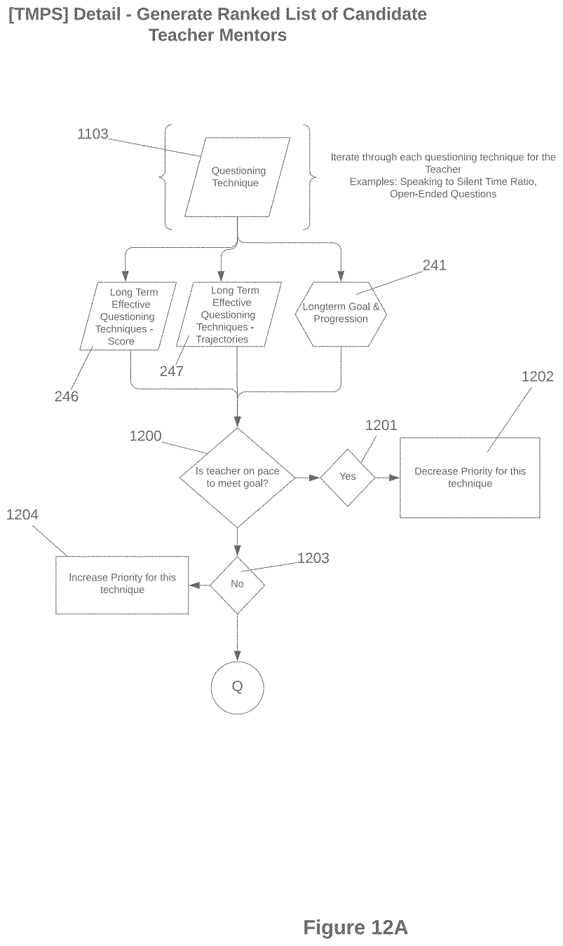

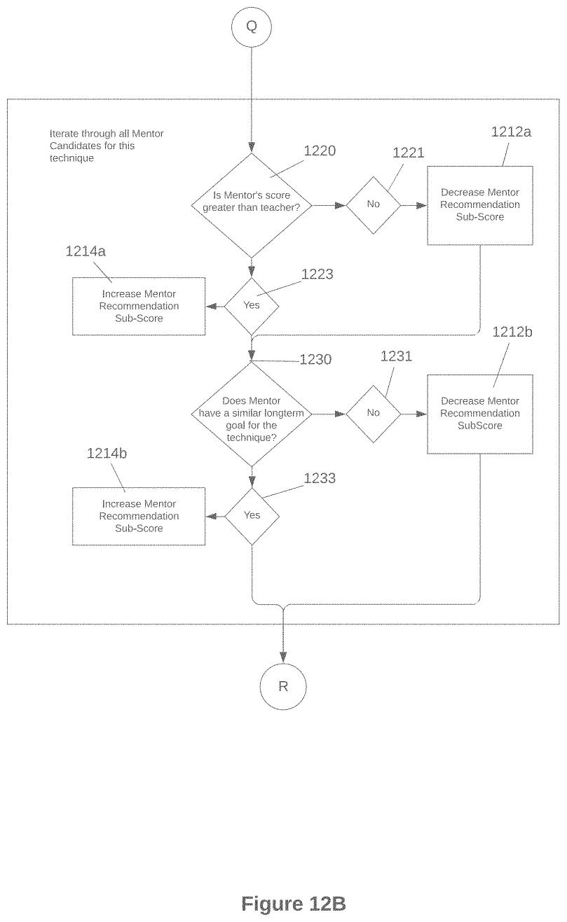

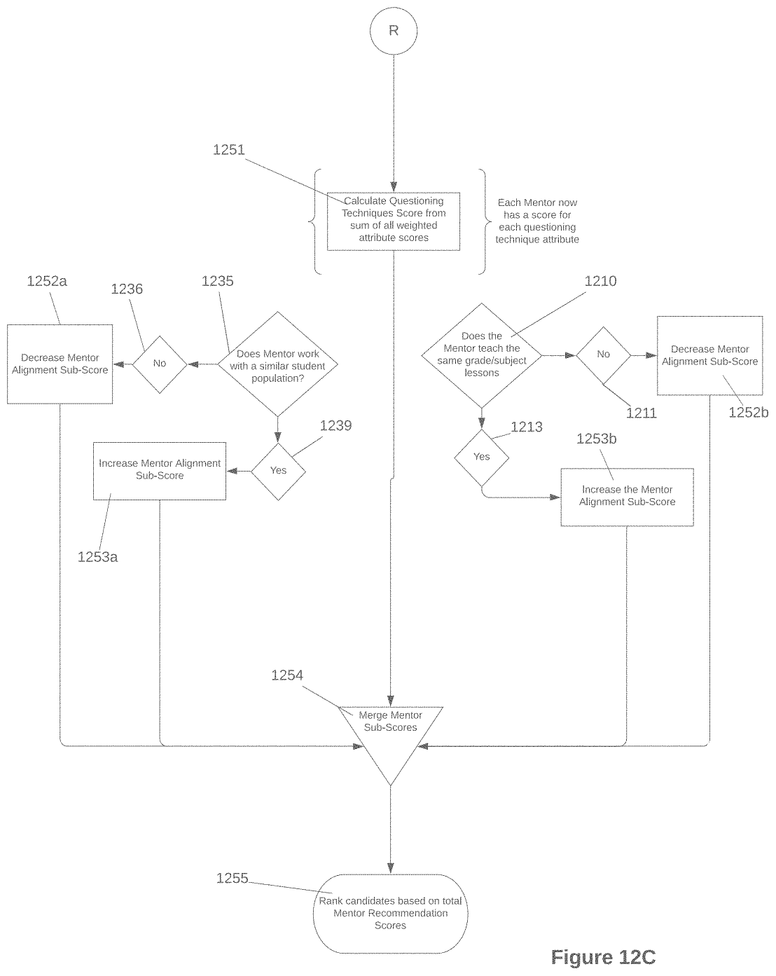

FIGS. 12A, 12B, and 12C are flowcharts of operations for generating a list of mentor candidates. Referring to FIGS. 12A, 12B, and/or 12C, questioning techniques 1103 may include iterating through each of the questioning techniques in the teacher's profile. Here, the TMPS looks at the long-term scores, trajectories, and goals. This may include performance and progress over large time windows (e.g., months and years), but also shorter time windows (e.g., weeks and months). A determination may be made if a teacher is on pace to meet a goal, at block 1200. The matching algorithm may prioritize mentor matching based on questioning techniques where the teacher is falling short of stated long-term goals. If the teacher is on pace to meet a goal, at block 1201, the TMPS may decrease priority for this technique, at block 1202. If the teacher is on pace to achieve a goal, the sub-scores for this questioning technique may be weighted less than others. If the teacher is not on pace to meet a goal, at block 1203, then there may be an increase in priority for this technique, at block 1204. If the teacher is not on pace to achieve a goal, the sub-scores for this questioning technique may be weighted more than others. This weighting may be in proportion to the distance the teacher is from achieving their goal.

According to some embodiments, it may be determined if the mentor's score is greater than the teacher, at block 1220. Drawing on data from the database, the algorithm may determine if the mentor's score is greater than the teacher. A candidate who is more proficient than the teacher may be considered as a mentor match in this particular technique. If the mentor's score is not greater than that of the teacher, at block 1221, the mentor recommendation sub-score may be decreased, at block 1212a-b. This decreases the likelihood that this mentor will rank highly. If the mentor's score is greater than that of the teacher, at block 1223, the mentor recommendation sub-score may be increased, at block 1214a-b. This increases the likelihood that this mentor will rank highly. It may then be determined if the mentor has a similar long-term goal for the technique, at block 1230. The recommendation score may be influenced by the extent to which the teacher and mentor share the same goals. If two educators are working toward the same goal, they may have a shared desire to focus on those specific techniques together. If they do not share a similar long-term goal, at block 1231, then the mentor recommendation sub-score may be decreased, at block 1212b. If they do share a similar long-term goal, at block 1233, then the mentor recommendation sub-score may be increased, at block 1214b. The questioning techniques recommendation score may be determined from the sum of all weighted attribute scores, at block 1251. The TMPS may evaluate each priority questioning technique for the mentor. These sub-scores may be compiled using a weighted sum to provide a total questioning techniques score for the mentor.

Next, according to some embodiments, the TMPS may consider the overall alignment between the teacher and Mentor. Specifically, it may be determined if the mentor teaches the same grade/subject lessons, at block 1210. Drawing on data from the LMS, the TMPS may evaluate if the mentor teaches similar grades, subjects, and lessons. If the mentor does not teach similar grade/subject lessons, at block 1211, the TMPS may decrease mentor alignment sub-score, at block 1252a-b. The mentor recommendation is lowered because the mentor may not be optimally aligned. If the mentor does not teach similar grade/subject lesson, at block, 1213, the TMPS may increase the mentor alignment sub-score, at block 1252a-b. The mentor recommendation may be increased because the mentor is aligned. A determination may be made if the mentor works with a similar student population, at block 1235. The recommendation score may be influenced by the student populations that the teacher and mentor work with. This may include, but is not limited to, features such as geographic location and socio-economic status. If the mentor does not work with a similar population, at block 1236, then the mentor alignment sub-score may be decreased, at block 1252a. If the mentor does work with a similar population, at block 1239, then the mentor alignment sub-score may be increased, at block 1253a. The mentor sub-scores may be merged, at block, 1254. The sub-scores from the questioning techniques and alignment attributes are compiled to generate an overall mentor recommendation score for each Mentor in the candidate pool. The candidates may be ranked based on total mentor recommendation scores, at block 1255. The mentors may be arranged into a ranked order list based on their scores. The Ranked Mentor Candidate List with Annotations may be displayed, at block 1120. Once the system has generated a ranked list of potential mentors, the data may be provided to the teacher and/or other stakeholders in the organization. This feedback may be provided through a variety of ways, including, but not limited to direct email or text notifications, dashboard displays, and/or display embedded in 3rd party hardware and/or software applications. In addition to the list of potential mentors, the display mechanism includes detailed annotations that detail why the mentor would be a good match. This includes details such as the specific goals and trajectories that are well-aligned between the Teacher and Mentor, as well as attributes where the two might diverge. The teacher may select one or more mentors from the ranked list, at block 1121 of FIG. 11. Using the data and annotations from the ranked list, the teacher can select a mentor or mentors.

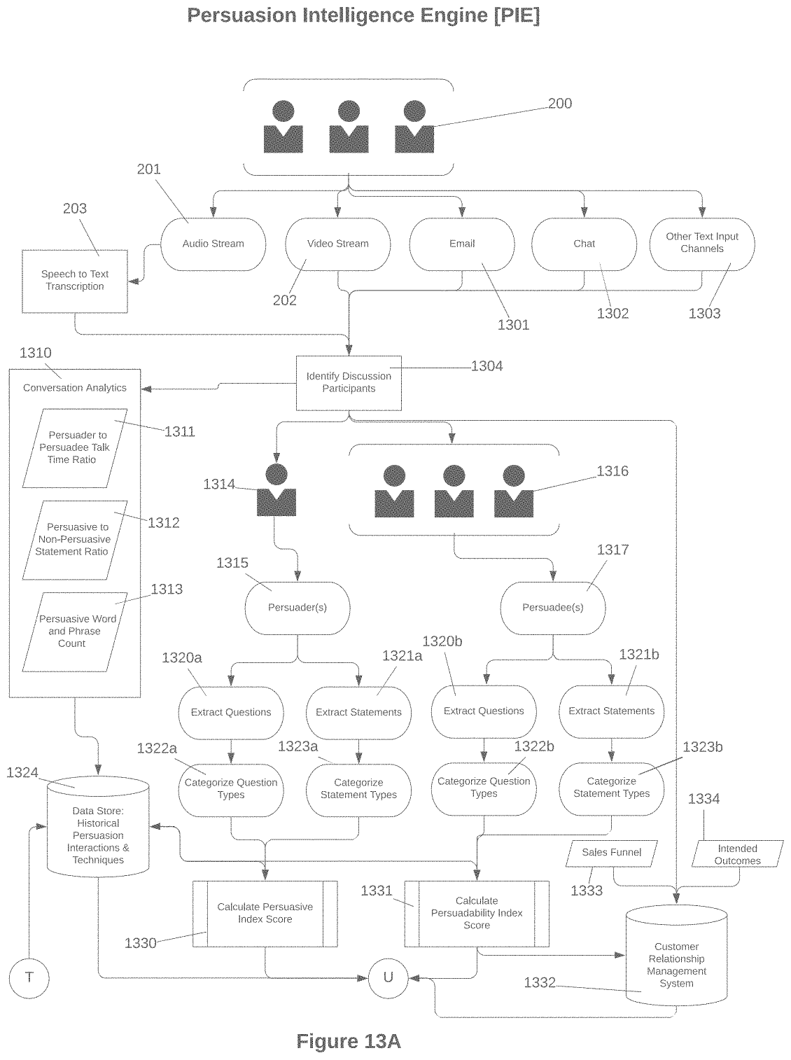

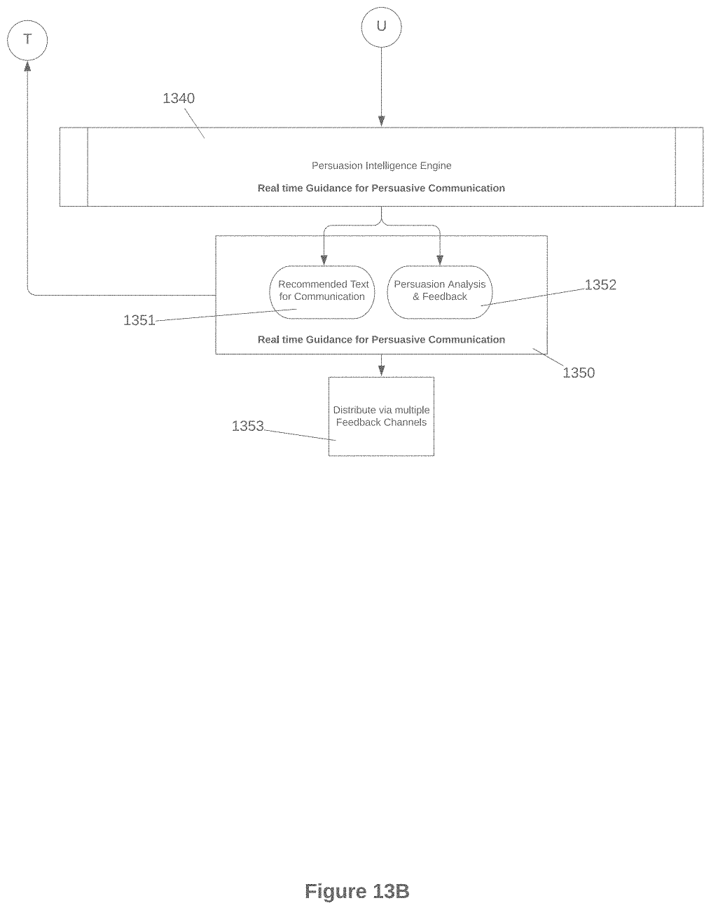

FIGS. 13A and 13B are flowcharts of operations of a Persuasion Intelligence Engine (PIE). The aim of the PIE is to provide real time analysis and recommendations to assist customer support agents, sales representatives, and marketing personnel in a business context with a specific focus on persuasion techniques. The PIE identifies persuasion techniques, analyzes their efficacy, and/or makes recommendations for using persuasion techniques across a range of communication channels. One aim of the PIE is to improve business outcomes in real time.

Prior academic research has identified a wide range of techniques that are known to be persuasive. These may be referred to as principles of persuasion. For example, the fear of loss is a principle of persuasion. If a subject is concerned that they might lose an opportunity in the future, they are likely to be persuaded to take action now. The PIE builds upon these underlying principles in multiple ways.

The PIE may identify the presence of persuasive techniques in communication between persuaders and persuadees. For example, if a sales representative writes, “I just checked with my inventory manager, and it looks like we only have a couple more in stock”, the system categorizes this as a persuasive statement that is linked to the principle of persuasion described above.

The PIE may identify the presence of persuasive techniques that are poorly implemented. If a sales representative writes, “I'm not sure if this product will help you save money or not,” the PIE may detect that the persuader is violating a principle of persuasion: project confidence.

These persuasion techniques may be linked to business outcomes to measure their effectiveness in the past and predict their effectiveness in current communications. Thus, the PIE may generate real time guidance and monitor outcomes. The PIE may feed this data back into the recommendation engine to improve performance over time.

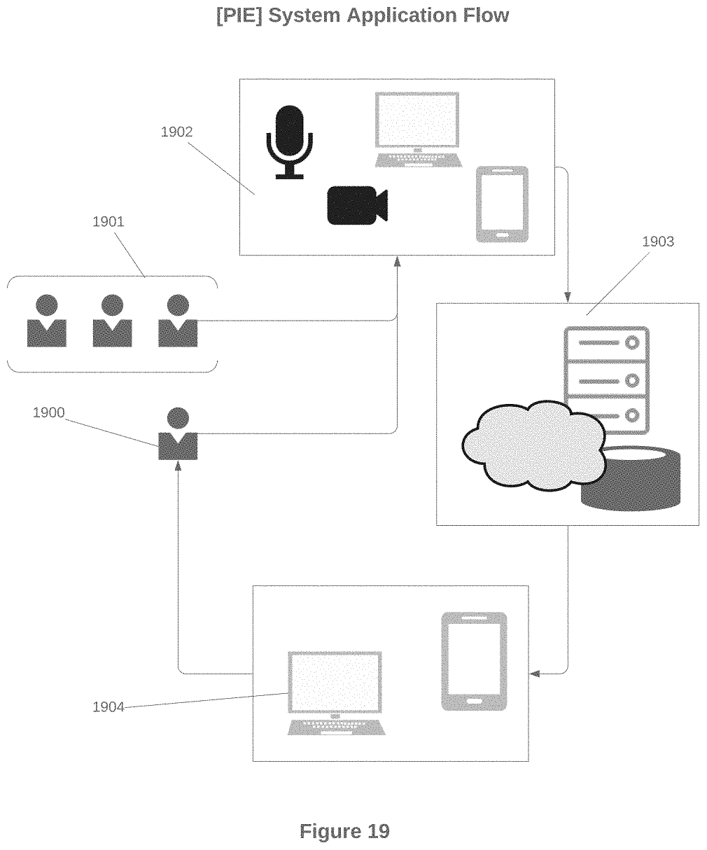

FIG. 19 illustrates the overall application flow of the PIE. Referring to FIG. 19, persuaders 1900 (e.g., sales representatives or customer service agents) may participate in a series of conversations with persuadees 1901. Persuaders may access real time guidance and archived reports generated by the PIE. Persuadees 1901 (e.g., potential customers or partners) may participate in a series of conversations with persuaders 1900. Audio and video devices may capture data representing the series of conversations, at block 1902. These conversations may unfold via phone, video conference, in person meetings, email, chat, and/or other channels. Data may be sent to the cloud where hardware and/or software analyzes and stores the data, at block 1903. Analyzed data may be sent to devices and hardware and/or software applications or output as guidance based on the analyzed data, at block 1904.

The PIE may share much of its architecture with the Effective Questioning Techniques in FIG. 2 and described above. Referring to FIGS. 13A and 13B, the PIE system will be described, noting the similarities and extensions where applicable. The PIE gathers input data across multiple channels that are common in business communication. These include, but are not limited to audio streams 201, video streams 202, email 1301, chat 1302, and/or other text input channels 1303. Speech to text transcription may be performed, at block 203, as described above. Discussion participants may be identified, at block 1304. The PIE may integrate audio and video streams to identify discussion participants as described above. The PIE may also integrate meta-data from email threads, chat logs, and other text sources to identify participants. These identifiers may include, but are not limited to email addresses, usernames, internet protocol addresses, and/or phone numbers. Participant roles 1314 and 1316 may be assigned such that each has specific roles in the PIE. A persuader 1315 may be typically a customer support agent, sales representative, evangelist, marketer, or other business role. The persuader may be motivated to persuade prospects, customers, and others to take a specific action. For example, the persuader might want others to make a purchase, accept a meeting, or advocate for a project. The PIE is designed to accommodate one or more persuaders. A persuadee 1317 may be participants whom the persuader is trying to persuade to take an action. For example, a persuadee could be a potential customer or a project leader at a partner company. The PIE is designed to accommodate one or more persuadees in a conversation. One or more conversation analytics may be determined, at block 1310. These meta-data may be akin to the Session Questioning Techniques described above. They may be determined based on analysis of communication channels, and the previously discussed techniques are modified where noted. The persuader to persuadee talk time ratio 1311 may indicate how much of the overall communication does the persuader own. In a voice phone call, the ratio may be determined based on how long the persuader speaks vs. the persuadees. In an email thread, the ratio may be determined based on the overall length of the emails sent by participants. Each of these examples may provide a sub-channel ratio over the life of the interaction. These sub-channel ratios may be calculated and stored. The overall ratio may be determined by a weighted-sum of the ratios across all sub-channels. The persuasive to non-persuasive statement ratio 1312 may indicate how frequently the persuader is communicating with language that reflects known persuasive techniques. Since humans are hard-wired to return a favor, if someone's cooperation is desired in the future, it may be beneficial to do something for them today. If a sales representative offers to extend a favor by writing, “I'll extend your service period for another 3-months for no charge,” this is an example of the persuader leveraging a principle of persuasion. Therefore, it may be identified as a persuasive statement. The persuasive word and phrase count 1313 may be a ratio that indicates how frequently the persuader is using known persuasion techniques in the communication. For example, if the persuader begins a paragraph with “What would it be like if . . . ” they are helping the subject to imagine an outcome. This is a technique that is known to be more persuasive than simply describing a product or feature.

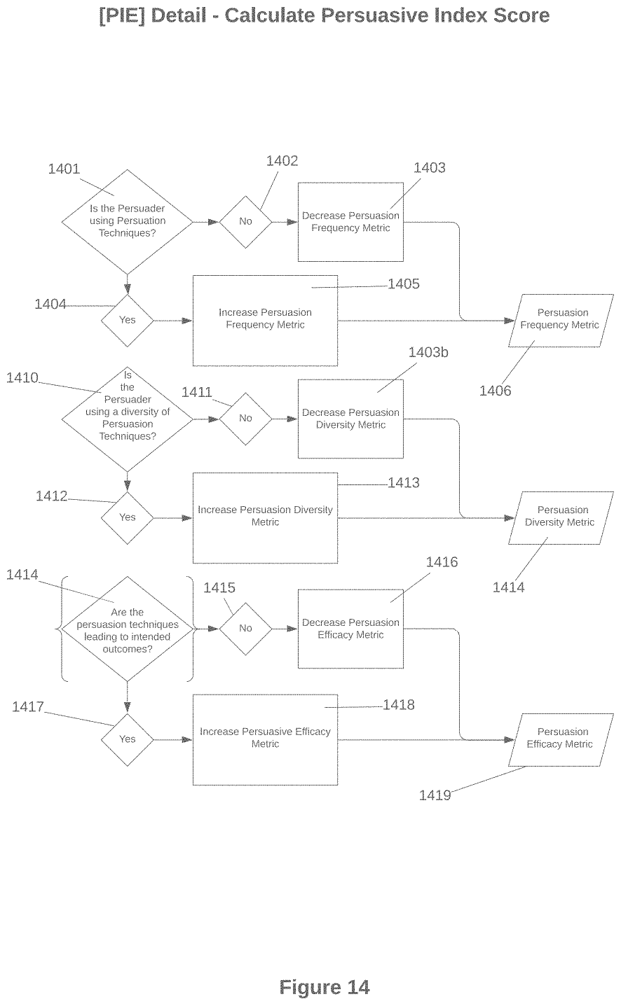

Still referring to FIGS. 13A and 13B, the PIE may extract questions 1320a-b and extract statements, at blocks 1321a-b. The PIE may analyze communications across input channels between the participants. As described above, the PIE may distinguish between questions and statements. This distinction may aid the system in identifying principles of persuasion in persuader communications, and movement toward intended outcomes in persuadees. The PIE may categorize question types, at blocks 1322a-b. As described above, the PIE may categorize the questions into a set of question-types. Here, the question types may be modified to suit a business application. Furthermore, the question types may be specific to known persuasion techniques as defined in prior research literature. The PIE may categorize statement types, at blocks 1323a-b. Using similar techniques as with questions, the PIE may also categorize statements into a set of statement-types. Again, the statement-types may be suited to a business application, and specific to known persuasion techniques. The PIE may use a data store for historical persuasion interactions and techniques, at block 1324. As described above, interactions, analyses, and data may be stored in a database. This data may be used to generate Persuasion Index Scores for persuaders, and/or calculate Persuadability Index Scores for persuadees. It also provides data to the Persuasion Intelligence Engine. Finally, it may support data reporting and display for individuals and organizations. The Persuasive Index Score 1330 may be an overall measure of the persuader's appropriate use of persuasion techniques and how effective they are at achieving intended outcomes. It may be determined based on the weighted sum of multiple factors as will be discussed with respect to FIG. 14.

FIG. 14 is a flowchart of operations for calculating the Persuasive Index Score. Referring to the FIG. 14, it may be determined if the persuader is using persuasion techniques, at block 1401. Based on the analysis described above, it be may be determined if the system detects the presence of persuasion techniques in the communication. If not, at block 1402, the Persuasion Frequency Metric may be decreased, at block 1403. The score may be reduced to reflect the negative impact of this factor. The Persuasion Frequency Metric 1406 may be a measure of how often the Persuader uses persuasive techniques. It may be used as a sub-component of the Persuasive Index. If there is a presence of persuasion techniques in the communication, at block 1404, the Persuasion Frequency Metric may be increased, at block 1405. The score may be increased to reflect the positive impact of this factor. The PIE may determine if the persuader is using a diversity of persuasion techniques, at block 1410. Based on the analysis described above, the PIE may detect the presence of multiple types of persuasion techniques in the communication. If not, at block 1411, Persuasion Diversity Metric may be decreased, at block 1413. Decrease the score to reflect the negative impact of this factor. The Persuasion Diversity Metric 1414 is a measure of how many different types of persuasion techniques the persuader uses and how often each is used. It may be used as a sub-component of the Persuasive Index. If there is a presence of multiple types of persuasion techniques, at block 1412, then the Persuasive Diversity Metric may be increased, at block 1413. The score is increased to reflect the positive impact of this factor.

Still referring to FIG. 14, it may be determined if the persuasion techniques are leading to intended outcomes, at block 1414. Using data from the Customer Relationship Management (CRM) system and conversation analysis, the system has contextual knowledge of what the persuader is trying to persuade a given persuadee to do. For example, the persuader may want to trigger a follow-up sales call or in-person meeting. This data is linked back to the use of persuasion techniques in a given conversation to determine if the technique led to the intended outcome. If yes, the efficacy metric is increased. If not, the efficacy metric is decreased. This analysis may be repeated for every persuasion technique that is identified in the conversation in order to calculate an overall Persuasion Efficacy Metric. If the persuasion techniques are not leading to intended outcomes, at block 1415, the Persuasion Efficacy Metric may be decreased, at block 1416. Decreasing the score reflects the negative impact of this factor. The Persuasion Efficacy Metric 1419 is a measure of how effective the persuasion techniques are when used by this persuader. It may be used as a sub-component of the Persuasive Index. If the persuasion techniques are leading to intended outcomes, at block 1417, the Persuasion Efficacy Metric may be increased, at block 1418. Increasing the score reflects the positive impact of this factor.

The PIE may dynamically adjust the algorithm weights based on their known effectiveness. It will also factor in response data such as but not limited to, emails being opened, replies, buttons clicked, phone numbers called, and conversion events. The PIE may become smarter over time for a specific organization and individual persuaders and persuadees as it learns what techniques are most effective. A low score indicates that the persuader has historically been ineffective at using persuasion techniques to yield intended outcomes. A high score indicates that the persuader makes frequent use of a range of persuasion techniques, and often succeeds at earning the intended outcome. The Persuadability Index Score 1331 is an overall measure of how receptive the persuadees are to persuasion techniques. It is calculated by analyzing the extent to which multiple persuasion techniques have led to intended outcomes.

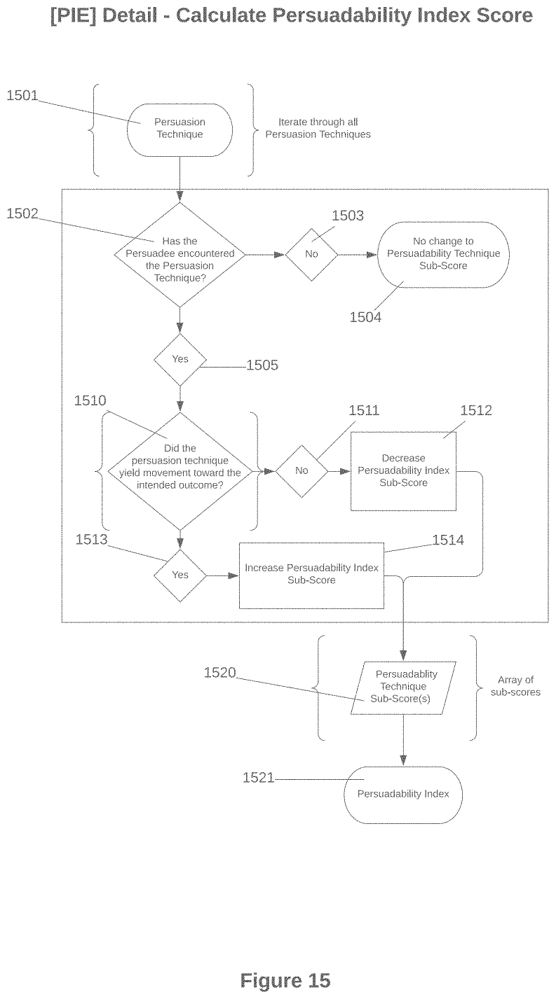

FIG. 15 is a flowchart of operations for calculating the Persuadability Index Score. The PIE may iterate through the known principles of persuasion and persuasion techniques to analyze each, at block 1501. A Persuadability Technique Sub-Score 1520 may be generated for each. It may be determined if the persuadee encountered the persuasion technique, at block 1502. The PIE analyzes prior conversations that include the persuadee. It detects the presence of the given persuasion technique in the conversation. If the persuadee has not encountered the persuasion technique, at block 1503, then no change is made to Persuadability Technique Sub-Score, at block 1504. If the persuadee has not encountered the technique, the PIE has insufficient data to determine its efficacy. If the persuadee has encountered the persuasion technique, at block 1505, analysis is continued.

Still referring to FIG. 15, it may be determined if the persuasion technique yielded movement toward the intended outcome, at block 1510. The PIE may iterate through each instance of the persuasion technique that is detected in prior conversations. In each instance, the PIE may identify the intended outcome and scan for subsequent evidence that the persuadee took positive action toward that outcome. If the persuasion technique did not yield movement toward the intended outcome, at block 1511, then there may not be evidence that the persuadee took an action toward the intended outcome, or there may be evidence that the persuadee took an action moving away from an intended outcome (e.g., unsubscribing from an email list). In this case, the Persuadability Index Sub-Score 1512 may be decreased to reflect the data. If the persuasion technique yielded movement toward the intended outcome, at block 1513, then there may be evidence that the persuadee took an action toward the intended outcome. For example, an intended outcome might be to arrange a follow up sales call. Movement toward or away from the intended outcome may be inferred from multiple event signals including, but not limited to, email opens, replies, phone number dials, social media engagements, or questions asked, and statements made. An example of movement toward the intended outcome could be a response email with questions about the contract, installation timeframe, or financing options. Some examples of movement away from the intended outcome are replies with statements asking for no further communication, questioning the validity of statements made, or showing preference for a competitive product. The Persuadability Index Sub-Score may be increased to reflect the data, at block 1514.

Still referring to FIG. 15, persuadability technique sub-scores may be determined, at block 1520. Once the system has iterated through all of the persuasion techniques for this persuadee, an array of sub-scores may have been generated. The PIE may generate an overall Persuadability Index 1521 by calculating a weighted sum of the sub-scores. A low Persuadability Index may indicate that persuasion techniques are unlikely to yield the intended outcome. A high Persuadability Index may indicate that persuasion techniques are highly likely to yield the intended outcome. The PIE may improve over time as the efficacy of specific persuasion techniques for this Persuadee are evaluated and archived in the data store. The database of persuadees and known effective persuasion techniques may be a valuable asset that can be leveraged for other related commercial applications. Persuadees may be linked to multiple attributes including, but not limited to, email, phone, address, and IP address. These attributes may be stored in the database or CRM or both.

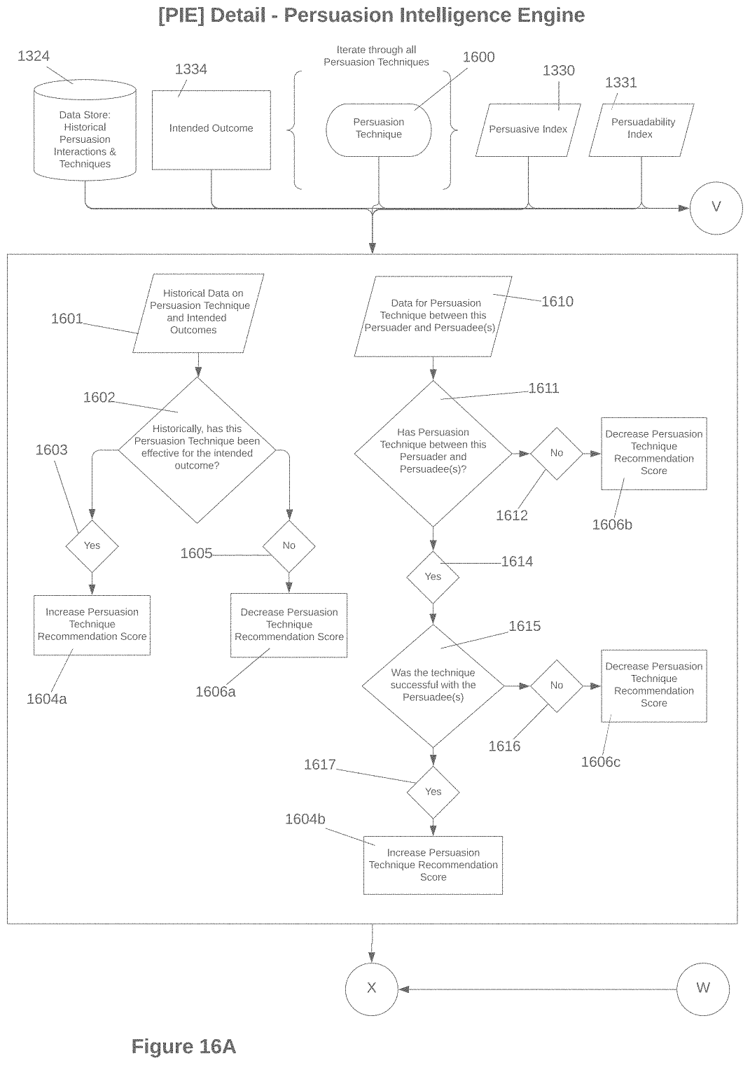

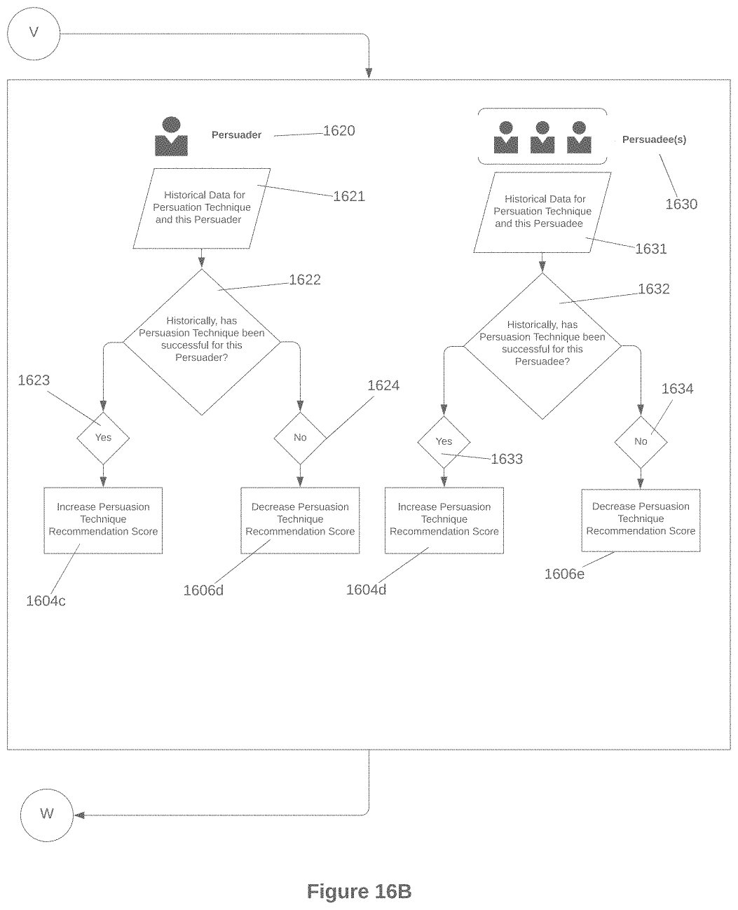

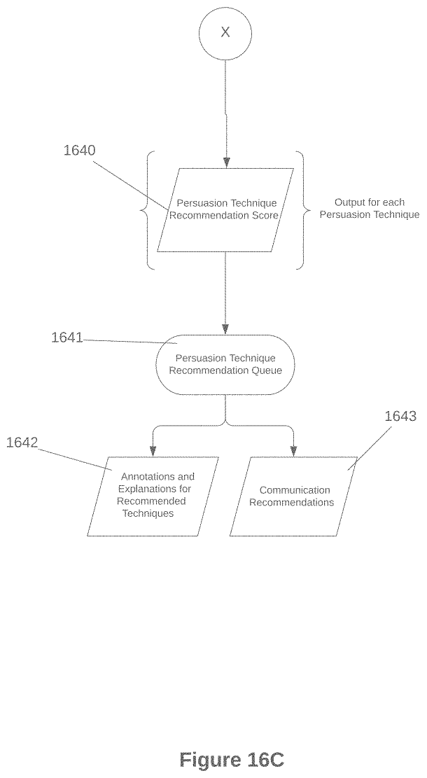

FIGS. 16A, 16B, and 16C are flowcharts of operations of the Persuasion Intelligence Engine. The Persuasion Intelligence Engine 1340 uses the Persuasive Index Score, the Persuadability Index Score, historical data about effective persuasion techniques, and/or historical data about the specific persuader/persuadee interactions to generate real time guidance for persuasive communication. Outputs from the Persuasion Intelligence Engine feedback to the data store. In this way, the system benefits from the overall history of interactions and may continue to improve over time. Referring to FIGS. 16A, 16B, and 16C, the data store may include historical persuasion interactions and techniques, at 1324. The engine may draw data from the data store to inform recommendations based on the historical effectiveness of a persuasion technique in a given situation. This may include data about effectiveness across some or all users, and the specific persuader/persuadee conversation in question. The data store may house data regarding the underlying principles of persuasion and how these are expressed through multiple persuasion techniques. Intended Outcome 1334, including two example ways that the intended outcome can be determined will now be discussed.

In advance of generating the communication (e.g.—before writing an email or calling a customer), the CRM may provide data about the intended outcomes from the conversation. For example, in a sales conversation, the CRM may provide data about the sales cycle, the persuadees' stage in the cycle, and the desired outcome to advance the Persuadees to the next stage of the cycle. While engaged in communication, the PIE may analyze the questions and statements to categorize the intended outcome. For example, if an email begins with the statement, “I'm writing to see if we can schedule a call to address your concerns,” the PIE may link this to a new phone call as the intended outcome.

The PIE may iterate through one or more of the persuasion techniques 1600 to calculate a sub-score for each technique. The sub-score may be calculated based on several considerations. Historical data on persuasion technique and intended outcome, at block 1601, may include looking across this history of prior conversations across all users and persuasion techniques that are used. It may be determined if this persuasion technique has been effective historically for the intended outcome, at block 1602. If it has been determined to be effective at achieving the intended outcome that the persuader is hoping to achieve, at block 1603, the Persuasion Technique Recommendation Score may be increased, at blocks 1604a-d. The persuasion technique is likely to be effective, so the PIE increases the likelihood of recommending it to the persuader. If it has been determined to not be effective at achieving the intended outcome that the persuader is hoping to achieve, at block 1604, the Persuasion Technique Recommendation Score is decreased, at blocks 1606a-e. The persuasion technique is not likely to be effective, so the PIE decreases the likelihood of recommending it to the persuader. Data for the persuasion technique between the persuader and persuadees is determined, at block 1610, by looking at this conversation so far between this persuadee and persuadees. It may be determined if the persuasion technique is used between this persuader and persuadees, at block 1611. If not, at block 1612, then the Persuasion Technique Recommendation Score is decreased, at block 1606b. Since there is not evidence that it will be effective the PIE decreases the likelihood that it will be recommended. If the persuasion technique is used between this persuader and persuadees, at block 1614, the analysis is continued.

Still referring to FIGS. 16A, 16B, and 16C, it may be determined if the technique is successful with the Persuadees, at block 1615. The PIE may analyze the intended outcome and subsequent actions to determine if the persuasion technique is linked to a positive outcome. If the technique is successful at block 1617, then the Persuasion Technique Recommendation Score is increased at blocks 1604a-d. If the technique is not successful, at block 1616, the Persuasion Technique Recommendation Score is decreased, at blocks 1606a-e. The persuader's 1620 past performance may be examined. Historical data for the persuasion technique and this persuader may be analyzed, at block 1621, by looking across the history of conversations that involve this persuader. It may be determined if this persuasion technique has been successful historically for this persuader, at block 1622. This analysis may be similar to block 1610 above, but may not be limited to conversations that include the current persuadees. If this persuasion technique has been successful historically for this persuader, at block 1623, then the Persuasion Technique Recommendation Score may be increased, at blocks 1604a-d. If this persuasion technique has not been successful historically for this persuader, at block 1624, then the Persuasion Technique Recommendation Score may be decreased, at blocks 1606a-e.

In some embodiments, the persuadees 1630 past performance may be examined. It may be determined if there is historical data for persuasion techniques with this persuadee, at block 1631. If the historical data is available, the history of conversations that involve this persuader is analyzed. It may be determined if a persuasion technique has been successful historically for this persuadee, at block 1632. This analysis may be similar to block 1611 above, but is not only limited to conversations that include this persuader. If the persuasion technique has been successful historically for this persuadee, at block 1633, Persuasion Technique Recommendation Score may be increased, at blocks 1604a-d. If the persuasion technique has not been successful historically for this persuadee, at block 1634, the Persuasion Technique Recommendation Score may be decreased, at blocks 1606a-e.

Still referring to FIGS. 16A, 16B, and 16C, the Persuasion Technique Recommendation Score may be determined, at block 1640. The PIE may calculate an overall recommendation score for each persuasion technique based on a weighted-sum of the three sub-scores described above. These may be arranged as an array of scores, one for each persuasion technique. The persuasion techniques may be rank ordered into the persuasion technique recommendation queue, at block 1641. Annotations and explanations for recommended techniques may be generated, at block 1642, to explain to the persuader why each persuasion technique is recommended in this situation. For example, if the persuader has written a lengthy email, an applicable persuasion technique may be to leave out unimportant details. The explanation might read, “To help your audience embrace your point of view, leave OUT any detail that is unimportant and especially avoid any details that might give them a reason to think, ‘That's not me’”. Communication recommendations may be generated, at block 1643. Where possible, the persuasion technique may be presented as a specific communication recommendation that can be directly integrated into the conversation between persuader and persuadee. For example, if the persuader has written a lengthy email, an applicable persuasion technique may be “Visual persuasion is more powerful than nonvisual”. Here, the PIE engine may recommend “Your email is too wordy and is unlikely to be effective. Try inserting a high-quality diagram and remove some of the text to increase effectiveness”.

Referring once again to FIGS. 13A and 13B, the Persuasion Intelligence Engine (PIE) may generate real time guidance for persuasive communication, at block 1350, and render two types of guidance, as will now be discussed. Recommended text for communication may be provided, at block 1351. The PIE makes specific recommendations for sentences, phrases, or words that can be inserted into a phone conversation, email, chat window or other communication channel. In some embodiments, such as a fully- or semi-automated chatbot, the PIE can automatically generate and broadcast statements directly to persuadees. The recommended text applies a known persuasion technique that is likely to achieve an intended outcome. Persuasion analysis and feedback may be provided, at block 1352. The PIE may provide a summary analysis of how persuasion techniques are influencing the conversation. This analysis and feedback may raise the persuader's awareness of each technique to help identify successful techniques and improve performance over time. In short, it may be a summary presentation of what persuasion techniques are working and which ones are not working in the conversation. The guidance may be distributed via multiple feedback channels, at block 1353. The real time guidance may be presented to the persuader and other stakeholders through a variety of channels including, but not limited to email messages, online dashboards, and/or integration into 3rd party hardware and/or software applications (e.g. email or chat client).

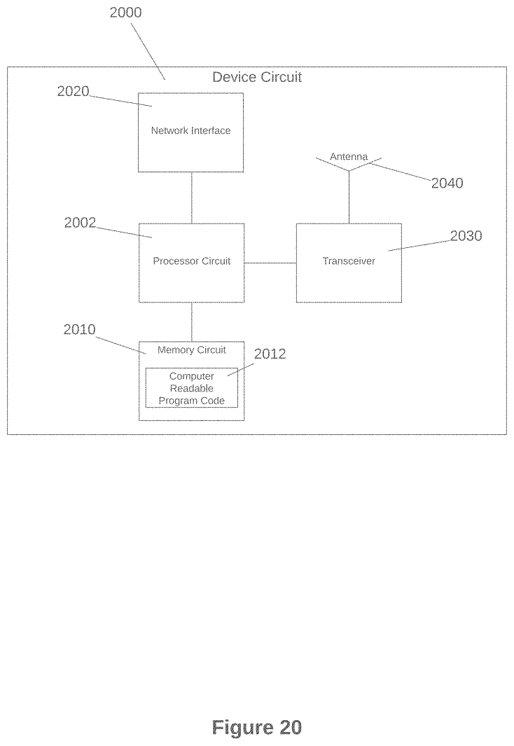

FIG. 20 is a block diagram of a device 2000 that is configured according to one or more embodiments disclosed herein. The device 2000 may include a transceiver 2030, one or more antennas 2040, a network interface 2020, a processor circuit 2002, and a memory circuit 2010 containing computer readable program code 2012. The processor circuit 2002 may include one or more data processing circuits, such as a general purpose and/or special purpose processor, e.g., microprocessor and/or digital signal processor that may be collocated or distributed across one or more networks. The processor circuit 2002 (also referred to as a processor) is configured to execute the computer readable program code 2012 in the memory 2010 to perform at least some of the operations and methods of described herein as being performed by the device 2000. For example, processor 2002 may be configured to perform operations discussed above with respect to FIGS. 1-19. The network interface 2020 communicates with other devices that are co-located, across a network, or in the cloud.

### Further Definitions

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art, and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that, although the terms first, second, third, etc. may be used herein to describe various elements, and elements should not be limited by these terms; rather, these terms are only used to distinguish one element from another element. Thus, a first element discussed could be termed a second element without departing from the scope of the present inventive concepts.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BluRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

The flowcharts and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination. Many variations and modifications can be made to the embodiments without substantially departing from the principles described herein. All such variations and modifications are intended to be included herein within the scope of the present inventive concepts.

1. A method of providing feedback to a participant, the method comprising:
receiving by a transceiver, from an electronic recording device, signals comprising audio information and/or video information associated with the participant and one or more recipients;
determining a first question and/or a first statement provided by the participant based on analyzing the audio information and/or the video information that was received;
identifying a second question and/or a second statement provided by the one or more recipients based on the analyzing the audio information and/or the video information;
generating an output comprising guidance to the participant based on one or more of the first question, the first statement, the second question, or the second statement; and
transmitting the output comprising the guidance to an electronic device for display to the participant.

2. The method of claim 1, further comprising:
identifying one or more persons based on the audio information and/or the video information that was received; and
identifying a first person of the one or more persons as the participant and identifying a second person of the one or more persons as a recipient of the one or more recipients.

3. The method of claim 2, further comprising:
determining a question type of the first question, wherein the question type comprises an open ended question, a content specific question, or a knowledge connection question.

4. The method of claim 1, wherein the generating the output comprising the guidance to the participant comprises:
determining a check for understanding score based on the second question and/or the second statement from the one or more recipients; and
generating the output comprising the guidance to the participant based on the check for understanding score.

5. The method of claim 4, further comprising:
determining a question type of the first question, wherein the question type comprises an open ended question, a content specific question, a general affirmation question, a classroom logistics question, or a knowledge connection question; and
determining a proficiency score and/or a higher order thinking score based on the question type,
wherein the check for understanding score is based on the proficiency score and/or the higher order thinking score.

6. The method of claim 1, wherein the guidance to the participant comprises recommended questions for the participant.

7. The method of claim 6,
wherein the recommended questions for the participant are based on goals of the participant.

8. The method of claim 7,
wherein the recommended questions for the participant are further based on progress towards the goals of the participant.

9. The method of claim 7, further comprising:
determining respective current scores associated with respective attributes related to the goals of the participant; and
determining distances from the respective current scores to respective target scores of the respective attributes,
wherein the guidance to the participant is based on the distances.

10. The method of claim 9, further comprising:
prioritizing ones of the attributes based on the distances that were calculated; and
determining the guidance to the participant based on the ones of the attributes that were prioritized.

11. The method of claim 10, wherein the attributes of the participant comprise a speaking time to silent time ratio, a question to statement ratio, and/or question types.

12. The method of claim 10, wherein prioritizing ones of the attributes comprises:
determining strategy recommendation priorities and/or question recommendation priorities.

13. The method of claim 1, further comprising:
generating a list of mentor candidates; and
recommending a mentor to the participant.

14. The method of claim 13, wherein the list of mentor candidates comprises a ranked list of mentor candidates based on associating parameters between the participant and the mentor candidates.

15. The method of claim 14, wherein the ranked list of mentor candidates is based on historical information related to effectiveness of the mentor candidates.

16. The method of claim 15, wherein the ranked list of mentor candidates is further based on goals of the participant.

17. The method of claim 13, wherein generating the list of the mentor candidates comprises:
generating a ranked list of mentor candidates based on respective proficiencies of ones of the mentor candidates in one or more attributes related to a goal of the participant.

18. The method of claim 13, wherein generating the list of the mentor candidates comprises:
transmitting a query to a database;
identifying, based on the query, a list of mentor candidates from potential mentors in the database;
generating a ranked list of mentor candidates based on comparing questioning techniques of the participant and questioning techniques of ones of the mentor candidates; and
identifying a mentor to recommend to the participant out of the potential mentors in the database.

19. A computer program product, comprising:
a tangible, non-transitory computer readable storage medium comprising computer readable program code embodied therein, the computer readable program code comprising:
computer readable code to receive from a transceiver, signals comprising audio information and/or video information associated with a participant and one or more recipients;
computer readable code to determine a first question and/or a first statement provided by the participant based on analyzing the audio information and/or the video information that was received;
computer readable code to identify a second question and/or a second statement provided by the one or more recipients based on the analyzing the audio information and/or the video information;
computer readable code to generate an output comprising guidance to the participant based on one or more of the first question, the first statement, the second question, or the second statement; and
computer readable code to transmit the output comprising the guidance to an electronic device for display to the participant.

20. An electronic device comprising:
a processor;
a transceiver; and
a memory coupled to the processor, the memory comprising computer readable program code embodied therein that, when executed by the processor, causes the processor to perform operations comprising:
receiving by the transceiver, signals comprising audio information and/or video information associated with a participant and one or more recipients;
determining a first question and/or a first statement provided by the participant based on analyzing the audio information and/or the video information that was received;
identifying a second question and/or a second statement provided by the one or more recipients based on the analyzing the audio information and/or the video information;
generating an output comprising guidance to the participant based on one or more of the first question, the first statement, the second question, or the second statement; and
transmitting the output comprising the guidance to a device for display to the participant.
